(19) United States
(12) Patent Application Publication
(10) Pub. No.: US 2018/0203398 A1
(43) Pub. Date: Jul. 19, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Kazufumi ISHIDA, Sunto Shizuoka (JP)

(21) Appl. No.: 15/653,526

(22) Filed: Jul. 19, 2017

(30) Foreign Application Priority Data
Jan. 19, 2017 (JP) 2017-007482

(51) Int. Cl. G03G 15/00

(52) U.S. Cl. CPC G03G 15/6576; G03G 15/6582; B41J 11/0005; G03G 2215/00662; G03G 15/2053

(57) ABSTRACT

An image forming apparatus includes an image forming section, a sheet supply section, and first and second curl correction mechanisms disposed in a sheet conveyance path between the sheet supply section and the image forming section and configured to curve a recording medium conveyed thereto. The first and second curl correction mechanisms are configured to apply curves to the recording medium in different curvature directions.

This application is based upon and claims the benefit of priority from Japanese Patent Application No. 2017-007482 filed Jan. 19, 2017, the entire contents of which are incorporated herein by reference.

### FIELD

Embodiments described herein relate generally to an image forming apparatus.

### BACKGROUND

Image forming apparatuses such as a multifunction peripheral (hereinafter, referred to as “MFP”) and a printer are known. The image forming apparatus includes a fixing device. The fixing device includes a heat roller. The fixing device fixes a toner image onto a recording medium by heat of the heat roller. The fixing device is controlled to operate in a fixing mode or a decoloring mode. In the fixing mode, the toner image is fixed onto the recording medium. In the decoloring mode, the toner image on the recording medium is decolored. In the decoloring mode, the temperature of the heat roller is higher than that in the fixing mode.

Incidentally, a phenomenon may occur in which the recording medium is curved (hereinafter, referred to as a “curl”) due to pressing during the conveyance of the recording medium, heat or pressing during the fixing or decoloring, or the like. The generation of the curl of the recording medium may result in paper jamming in the middle of a conveying path and due to defective loading in a paper discharge tray.

An image forming apparatus including a curl removing device for the removal, reduction, or correction of a curl (hereinafter, referred to as “decurling”) is also known. The curl removing device is provided at a predetermined position in the middle of the conveying path.

However, in a configuration in which the curl removing device is provided only at the predetermined position, there is a possibility that it is not possible to perform appropriate decurling in a case where an excessively large curl is generated to such an extent that correction is not completely performed by one decurling operation.

### DESCRIPTION OF THE DRAWINGS

FIG. 1 is a diagram illustrating an example of an exterior of an image forming apparatus according to an embodiment.

FIG. 2 is a diagram illustrating an example of a schematic configuration of the image forming apparatus according to the embodiment.

FIG. 3 is a diagram illustrating an example of a schematic configuration of a fixing device according to the embodiment.

FIG. 4 is a diagram illustrating an example of a schematic configuration of a decurling device according to the embodiment.

FIG. 5 is a diagram illustrating an example of a schematic configuration of a first curl correction mechanism according to the embodiment.

FIG. 6 is a schematic diagram when a hard roller according to the embodiment is positioned at a first position.

FIG. 7 is a schematic diagram when the hard roller according to the embodiment is positioned at a second position.

FIG. 8 is a block diagram illustrating an example of a functional configuration of the image forming apparatus according to the embodiment.

FIG. 9 depicts a flow chart of an example of an operation of a decurling mechanism according to the embodiment.

FIG. 10 is a diagram illustrating an example of a method of detecting a curled state of a sheet according to the embodiment.

FIG. 11 is a diagram illustrating an example of a table when a decurling condition is set on the basis of a detection result of a curl detection section according to the embodiment.

FIG. 12 is a diagram illustrating an example of a fourth conveying path according to the embodiment.

FIG. 13 is a diagram illustrating a schematic configuration of a decurling device according to a modification example of the embodiment.

FIG. 14 is a diagram illustrating a schematic configuration of a winding prevention mechanism according to a modification example of the embodiment.

FIG. 15 is a diagram illustrating a sheet used for the examination of an uplift amount.

FIG. 16 is a diagram illustrating a relationship between the number of times of decoloring and an uplift amount.

FIG. 17 is a diagram illustrating a resin sheet based on A4 setting which is used for the examination of an uplift amount.

FIG. 18 is a diagram illustrating a resin sheet based on A4R setting which is used for the examination of an uplift amount.

FIG. 19 is a diagram illustrating a schematic configuration of a decoloring device according to a modification example of the embodiment.

### DETAILED DESCRIPTION

Embodiments provide an image forming apparatus capable of performing appropriate decurling.

In general, according to one embodiment, an image forming apparatus includes an image forming section, a sheet supply section, and first and second curl correction mechanisms disposed in a sheet conveyance path between the sheet supply section and the image forming section and configured to curve a recording medium conveyed thereto. The first and second curl correction mechanisms are configured to apply curves to the recording medium in different curvature directions.

Hereinafter, an image forming apparatus according to an embodiment will be described with reference to the accompanying drawings. Meanwhile, in the drawings, the same components are denoted by the same reference numerals and signs.

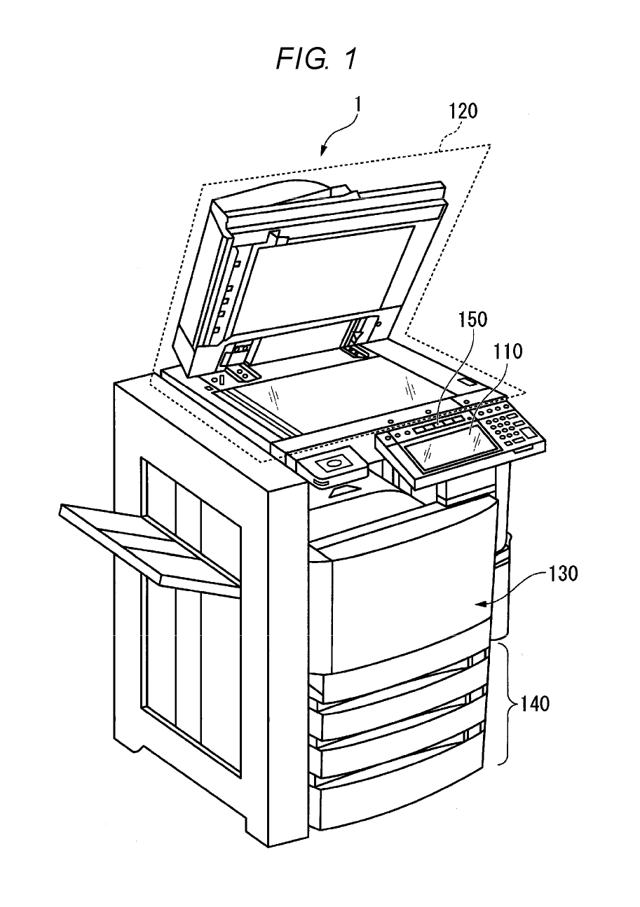

FIG. 1 is a diagram illustrating an example of an exterior of an image forming apparatus 1 according to the embodiment. For example, the image forming apparatus 1 is an MFP. The image forming apparatus 1 reads an image formed on a sheet-shaped recording medium (hereinafter, referred to as a “sheet”) such as paper to generate digital data (e.g., image file). The image forming apparatus 1 forms an image on a sheet using a toner on the basis of the digital data.

The image forming apparatus 1 includes a display section 110, an image reading section 120, an image forming section 130, and a sheet tray 140.

The display section 110 operates as an output device, and displays a character or an image. The display section 110 also operates as an input device, and receives a user's instruction. For example, the display section 110 is a touch panel type liquid crystal display.

For example, the image reading section 120 is a color scanner. The color scanner includes a contact image sensor (CIS), a charge coupled device (CCD), or the like. The image reading section 120 reads the image formed on the sheet by using the sensor to generate digital data.

The image forming section 130 forms an image on the sheet using the toner. The image forming section 130 forms an image on the basis of image data read by the image reading section 120 or image data received from an external apparatus. For example, the image formed on the sheet is an output image called a hard copy, a printout, or the like.

The sheet tray 140 supplies the sheet on which the image is to be formed to the image forming section 130.

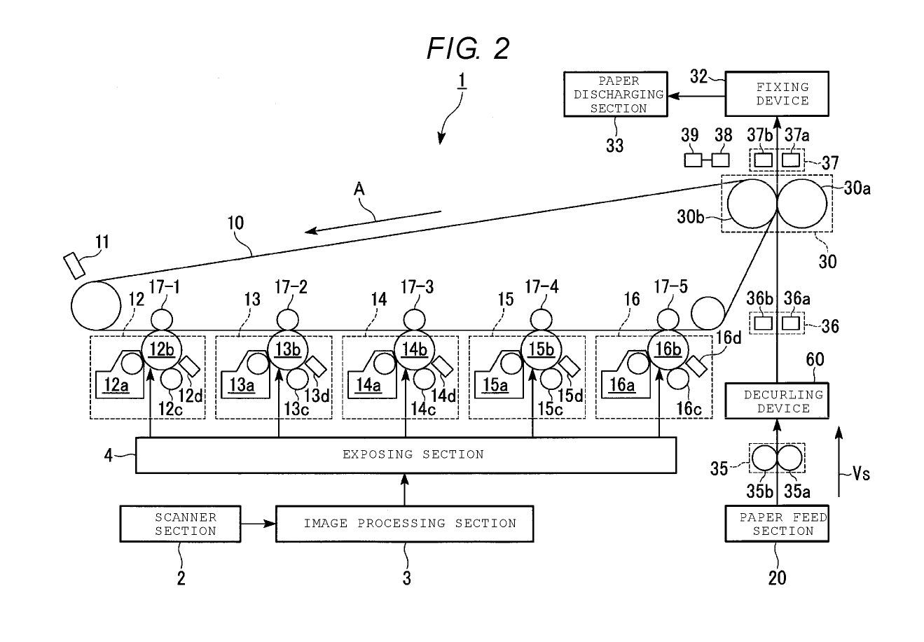

FIG. 2 is a diagram illustrating an example of a schematic configuration of the image forming apparatus 1 according to the embodiment. The image forming apparatus 1 is, for example, an electrophotographic image forming apparatus. The image forming apparatus 1 is a quintuple tandem type image forming apparatus.

Examples of the toner include a decolorable toner, a non-decolorable toner, a decorative toner, and the like. The decolorable toner has a characteristic of being decolored by an external stimulus. The term “decoloring” as used herein means that an image of a color (not only a chromatic color but also an achromatic color such as a white color and a black color is included) which is different from a base color of paper is made to be difficult to visually recognize. For example, the external stimulus is heat, light having a specific wavelength, pressure, or the like. In this embodiment, the decolorable toner is decolored when being heated at a temperature equal to or higher than a specific decoloring temperature. The color of the decolorable toner is developed when being heated at a temperature equal to or lower than a specific restoration temperature after the decoloring.

Any toner may be used as the decolorable toner as long as the toner has the above-described characteristic. For example, a color material of the decolorable toner may be leuco dye. The decolorable toner may be a toner obtained by appropriately combining the leuco dye, a developer and a decoloring agent, and the like.

In addition, a fixing temperature of the decolorable toner is lower than a fixing temperature of a non-decolorable toner. Here, the fixing temperature of the decolorable toner means the temperature of a heat roller 40 operating in a decolorable toner fixing mode to be described later. The fixing temperature of the non-decolorable toner means the temperature of the heat roller 40 operating in a monochrome toner fixing mode or a color toner fixing mode to be described later.

The fixing temperature of the decolorable toner is lower than the temperature of a process of decoloring the decolorable toner. Here, the temperature of the process of decoloring the decolorable toner means the temperature of the heat roller 40 operating in a decoloring mode to be described later.

The image forming apparatus 1 includes a scanner section 2, an image processing section 3, an exposing section 4, an intermediate transfer body 10, a cleaning blade 11, image creation sections 12 to 16, primary transfer rollers 17-1 to 17-5, a paper feed section 20, a decurling device 60, a secondary transfer section 30, a fixing device 32, a paper discharging section 33, and a control section 101.

Hereinafter, when it is not necessary to distinguish between primary transfer rollers, the primary transfer roller will be simply referred to as a primary transfer roller 17.

Meanwhile, in the following description, since a sheet is fed from the paper feed section 20 to the paper discharging section 33, the paper feed section 20 side is set to be an upstream side with respect to a sheet conveying direction Vs, and the paper discharging section 33 side is set to be a downstream side with respect to the sheet conveying direction Vs.

In FIG. 2, reference numeral 35 denotes a registration section, reference numeral 36 denotes a first guide, reference numeral 37 denotes a second guide, reference numeral 38 denotes a temperature detection section, and reference numeral 39 denotes a temperature adjusting section. The registration section 35 temporarily stops a sheet fed from the paper feed section 20. The registration section 35 sends out the sheet toward the secondary transfer section 30 in accordance with a timing when a toner image formed on the intermediate transfer body 10 is transferred in the secondary transfer section 30. The registration section 35 includes a pair of registration rollers 35a and 35b facing each other across a conveying path between the paper feed section 20 and the first guide 36.

The first guide 36 guides the sheet conveyed from the registration section 35 toward the secondary transfer section 30. The first guide 36 includes a pair of guide plates 36a and 36b facing each other across a conveying path between the registration section 35 and the secondary transfer section 30.

The second guide 37 guides the sheet having the toner image transferred in the secondary transfer section 30 toward the fixing device 32. The second guide 37 includes a pair of guide plates 37a and 37b facing each other across a conveying path between the secondary transfer section 30 and the fixing device 32.

The temperature detection section 38 detects the temperature of an atmosphere around the secondary transfer section 30. For example, the temperature detection section 38 is a temperature sensor.

The temperature adjusting section 39 adjusts the temperature of the atmosphere around the secondary transfer section 30 on the basis of a detection result of the temperature detection section 38. For example, the temperature adjusting section 39 is a fan. Meanwhile, the temperature adjusting section 39 may be provided for the purpose not only of adjusting the ambient temperature of the secondary transfer section 30 but also of exhausting ozone.

The transfer of a toner image performed in the image forming apparatus 1 includes a first transfer step and a second transfer step. In the first transfer step, the primary transfer roller 17 transfers a toner image formed on a photoreceptor drum of each image creation section onto the intermediate transfer body 10. In the second transfer step, the secondary transfer section 30 transfers toner images of respective colors stacked on the intermediate transfer body 10 onto a sheet.

The scanner section 2 reads an image formed on a sheet to be scanned. For example, the scanner section 2 reads the image on the sheet to generate image data of three primary colors of red (R), green (G), and blue (B). The scanner section 2 outputs the generated image data to the image processing section 3.

The image processing section 3 converts the image data into color signals of respective colors. For example, the image processing section 3 converts the image data into pieces of image data (color signals) of four colors of yellow (Y), magenta (M), cyan (C), and black (K). The image processing section 3 controls the exposing section 4 on the basis of color signals of respective colors.

The exposing section 4 irradiates (exposes) the photoreceptor drum of the image creation section with light. The exposing section 4 includes an exposure light source such as a laser or an LED.

The intermediate transfer body 10 is an endless belt. The intermediate transfer body 10 is rotated in a direction of an arrow A of FIG. 2. A toner image is formed on the outer peripheral surface of the intermediate transfer body 10.

The cleaning blade 11 removes a toner attached on the intermediate transfer body 10. For example, the cleaning blade 11 is a plate-shaped member. For example, the cleaning blade 11 is made of a resin such as a urethane resin.

The image creation sections 12 to 16 form an image using toners of respective colors (five colors in the example illustrated in FIG. 2). The image creation sections 12 to 16 are installed in order along the rotational direction of the intermediate transfer body 10.

The primary transfer rollers 17 (17-1 to 17-5) are used to transfer toner images, which are formed by the respective image creation sections 12 to 16, onto the intermediate transfer body 10.

The paper feed section 20 feeds a sheet.

The decurling device 60 is disposed on a downstream side of the paper feed section 20. In the embodiment, the decurling device 60 is disposed between the paper feed section 20 and the secondary transfer section 30. Specifically, the decurling device 60 is disposed between the registration section 35 and the first guide 36. In a case where a sheet is curled, the decurling device 60 corrects the curl by applying a curve to the sheet in an opposite direction of the curl of the curled sheet.

The secondary transfer section 30 includes a secondary transfer roller 30a and a secondary transfer counter roller 30b. The secondary transfer section 30 transfers a toner image formed on the intermediate transfer body 10 onto the sheet.

In the secondary transfer section 30, the out peripheral surface of the intermediate transfer body 10 and the secondary transfer roller 30a are in contact with each other. Meanwhile, in terms of the improvement related to paper jamming, the intermediate transfer body 10 and the secondary transfer roller 30a may be configured to be separable from each other.

The fixing device 32 fixes the toner image transferred onto the sheet to the sheet by heating and pressing. The sheet having the image formed by the fixing device 32 is discharged from the paper discharging section 33 to the outside of the device.

Next, the image creation sections 12 to 16 will be described. The image creation sections 12 to 15 accommodate toners of respective colors corresponding to four colors for color printing. The four colors for color printing are, for example, colors of yellow (Y), magenta (M), cyan (C), and black (K). The toners of the respective four colors for color printing are non-decolorable toners. The image creation section 16 accommodates a decolorable toner. The image creation sections 12 to 15 and the image creation section 16 accommodate different toners, but have the same configuration. Consequently, the image creation section 12 will be described as a representative of the image creation sections 12 to 16, and the other image creation sections 13 to 16 will not be described here.

The image creation section 12 includes a developing device 12a, a photoreceptor drum 12b, a charger 12c, and a cleaning blade 12d.

The developing device 12a accommodates a developer. The developer contains a toner. The developing device 12a attaches the toner to the photoreceptor drum 12b. For example, the toner is used as a one-component developer or may be used as a two-component developer by being combined with carriers. For example, iron powder or polymer ferrite particles having a particle diameter of several tens of μm are used as the carriers. In the embodiment, a two-component developer containing a nonmagnetic toner is used as an example.

The photoreceptor drum 12b is one of specific examples of an image carrier (image carrying means). The photoreceptor drum 12b has a photoreceptor (photosensitive region) on an outer circumferential surface. For example, the photoreceptor is an organic photoconductor (OPC).

The charger 12c uniformly charges the surface of the photoreceptor drum 12b.

The cleaning blade 12d removes the toner attached to the photoreceptor drum 12b.

Next, an outline of the operation of the image creation section 12 will be described.

The photoreceptor drum 12b is charged to a predetermined potential by the charger 12c. Next, the exposing section 4 irradiates the photoreceptor drum 12b with light. Thereby, the potential of a region irradiated with light in the photoreceptor drum 12b changes. An electrostatic latent image is formed on the surface of the photoreceptor drum 12b due to the change of the potential. The electrostatic latent image formed on the surface of the photoreceptor drum 12b is developed by the developer of the developing device 12a. That is, an image developed by the toner (hereinafter, referred to as a “developed image”) is formed on the surface of the photoreceptor drum 12b.

The developed image formed on the surface of the photoreceptor drum 12b is transferred onto the intermediate transfer body 10 by the primary transfer roller 17-1 facing the photoreceptor drum 12b (first transfer step).

Next, the first transfer step in the image forming apparatus 1 will be described. First, the primary transfer roller 17-1 facing the photoreceptor drum 12b transfers the developed image formed on the photoreceptor drum 12b to the intermediate transfer body 10. Next, the primary transfer roller 17-2 facing the photoreceptor drum 13b transfers a developed image formed on the photoreceptor drum 13b onto the intermediate transfer body 10. Such a process is also performed in the photoreceptor drums 14b, 15b, and 16b. At this time, the developed images formed on the respective photoreceptor drums 12b to 16b are transferred onto the intermediate transfer body 10 so as to overlap each other. For this reason, toner developed images of respective colors are transferred onto the intermediate transfer body 10, having passed through the image creation section 16, so as to overlap each other.

However, in a case where image forming using only a non-decolorable toner is performed, the image creation sections 12 to 15 operate. A developed image using only a non-decolorable toner is formed on the intermediate transfer body 10 by the operations. On the other hand, in a case where image forming using only a decolorable toner is performed, the image creation section 16 operates. A developed image using only a decolorable toner is formed on the intermediate transfer body 10 by the operation.

Next, a second transfer step will be described. A voltage (bias) is applied to the secondary transfer counter roller 30b. For this reason, an electric field is generated between the secondary transfer counter roller 30b and the secondary transfer roller 30a. The secondary transfer section 30 transfers the developed image formed on the intermediate transfer body 10 onto the sheet using the electric field.

Next, the fixing device 32 will be described.

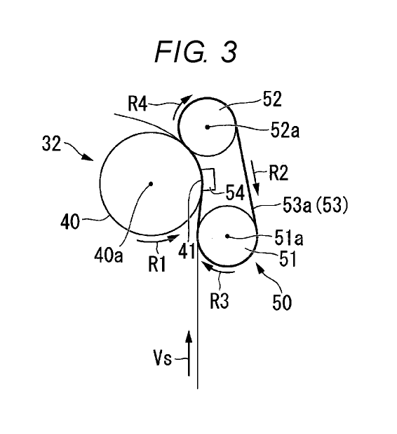

FIG. 3 is a diagram illustrating an example of a schematic configuration of the fixing device 32 according to the embodiment.

As illustrated in FIG. 3, the fixing device 32 includes the heat roller 40 (heating section) and a pressing section 50.

First, the heat roller 40 which is a heating unit will be described.

The heat roller 40 is disposed on a downstream side of the image forming section 130 (specifically, the secondary transfer section 30 illustrated in FIG. 2) in the sheet conveying direction Vs. The heat roller 40 is driven at two target temperatures to be described later. The heat roller 40 is an endless fixing member. The heat roller 40 has a curved outer circumferential surface. For example, the heat roller 40 has a cylindrical shape. The heat roller 40 includes a roller made of a metal. For example, the heat roller 40 includes a resin layer such as a fluororesin on the outer circumferential surface of a roller made of aluminum. The heat roller 40 is rotatable about a first shaft 40a. Here, the first shaft 40a means the central shaft (rotation shaft) of the heat roller 40.

Meanwhile, the fixing device 32 further includes a heat source (not shown) that heats the heat roller 40. For example, the heat source may be a resistive heating element such as a thermal head, a ceramic heater, a halogen lamp, an electromagnetic induction heating unit, or the like. The heat source may be disposed inside or outside the heat roller 40.

Next, the pressing section 50 will be described.

The pressing section 50 includes a plurality of rollers 51 and 52, a belt 53 (rotating body), and a pressing pad 54 (pressing member).

The plurality of rollers 51 and 52 are disposed on the inner side of the belt 53. In this embodiment, the plurality of rollers 51 and 52 includes a first roller 51 and a second roller 52. Meanwhile, the plurality of rollers 51 and 52 may be the same roller or may be different rollers.

The plurality of rollers 51 and 52 are respectively rotatable about a plurality of rotation shafts 51a and 52a that are parallel to the first shaft 40a. The plurality of rollers 51 and 52 are disposed at positions that contribute to the formation of a nip 41.

The first roller 51 is disposed on an upstream side of the second roller 52 in the sheet conveying direction Vs. The first roller 51 has a columnar shape. For example, the first roller 51 is a roller made of a metal such as iron. The first roller 51 is rotatable about the first rotation shaft 51a parallel to the first shaft 40a. Here, the first rotation shaft 51a means the central shaft of the first roller 51.

The second roller 52 is disposed on a downstream side of the first roller 51 in the sheet conveying direction Vs. The second roller 52 has a columnar shape. For example, the second roller 52 is a roller made of a metal such as iron. The second roller 52 is rotatable about the second rotation shaft 52a parallel to the first shaft 40a. Here, the second rotation shaft 52a means the central shaft of the second roller 52.

The outer peripheral surface of the belt 53 faces the heat roller 40. The belt 53 stretches between the first roller 51 and the second roller 52. The belt 53 has an endless shape.

The belt 53 includes a base layer 53a and a release layer which is formed on the outer circumferential surface of the base layer 53a (not shown). For example, the base layer 53a is formed of a polyimide resin (PI). For example, the release layer is formed of a fluororesin such as a tetra-fluoroethylene perfluoroalkyl vinyl ether copolymer resin (PFA). Meanwhile, a layered structure of the belt 53 is not limited. The belt 53 includes a film-shaped member.

The pressing pad 54 has a rectangular parallelepiped shape. For example, the pressing pad 54 is formed of a resin material such as a heat-resistant polyphenylene sulfide resin (PPS), a liquid crystal polymer (LCP), or a phenol resin (PF). The pressing pad 54 is disposed inside the inner circumferential surface of the belt 53 and at a position facing the heat roller 40 across the belt 53. The pressing pad 54 is biased toward the heat roller 40 by a biasing member (not shown) such as a spring. The pressing pad 54 abuts on the inner circumferential surface of the belt 53 to press the belt 53 against the heat roller 40, thereby forming the nip 41. That is, the pressing pad 54 presses the inner circumferential surface of the belt 53 against the heat roller 40 side to thereby form the nip 41 between the belt 53 and the heat roller 40.

Next, rotational directions of the heat roller 40 and the like will be described.

The heat roller 40 is rotated in a direction of an arrow R1 by a motor (not shown). That is, the heat roller 40 is rotated in the direction of the arrow R1 independently of the pressing section 50.

The belt 53 is rotated in a direction of an arrow R2 so that the outer circumferential surface of the belt 53 follows the outer circumferential surface of the heat roller 40. That is, the belt 53 abuts on the outer circumferential surface of the heat roller 40 which is rotated in the direction of the arrow R1, and thus is rotated so as to follow the rotation of the heat roller 40.

The first roller 51 is rotated in a direction of an arrow R3 so as to follow the belt 53. The second roller 52 is rotated in a direction of an arrow R4 so as to follow the belt 53. That is, the first roller 51 and the second roller 52 abut on the inner circumferential surface of the belt 53 rotated in the direction of the arrow R2, and thus are rotated so as to follow the belt 53.

Next, a type of image forming process performed by the image forming apparatus 1 (see FIG. 1) according to the embodiment will be described. The image forming apparatus 1 performs printing in the following three modes.
Monochrome toner mode: an image is formed using a non-decolorable black monochrome toner.
Color toner mode: an image is formed using a non-decolorable monochrome toner and a color toner.
Decolorable toner mode: an image is formed using only a decolorable toner.

A user can select in which mode an image is to be formed by operating the display section 110 of the image forming apparatus 1.

In the monochrome toner mode, an image is formed by the operation of an image creation section using a non-decolorable black (K) toner. The monochrome toner mode is a mode selected in a case where a user desires to print a general monochrome image. For example, the monochrome toner mode is used in a case where paper such as an important material is desired to be kept without being reused, and the like.

In the color toner mode, an image is formed by the operation of four image creation sections using respective non-decolorable toners of yellow (Y), magenta (M), cyan (C), and black (K). The color toner mode is a mode selected in a case where a user desires to print a color image.

In the decolorable toner mode, an image is formed by the operation of only an image creation section using a decolorable toner. The decolorable toner mode is a mode selected in a case where paper having an image formed thereon is reused.

The fixing device 32 is controlled to operate in a fixing mode and a decoloring mode. In the fixing mode, a toner image is fixed onto a sheet. In the decoloring mode, a toner image on a sheet is decolored. In the decoloring mode, the temperature of the heat roller 40 is higher than that in the fixing mode. That is, the control section 101 to be described later operates the fixing device 32 at at least two or more target temperatures. Specifically, two target temperatures of the fixing device 32 are stored in a memory 104 to be described later. The control section 101 acquires the target temperature from the memory 104 in accordance with a selected mode to operate the fixing device 32. The two target temperatures are a first temperature and a second temperature. Here, the first temperature is a target temperature in the decoloring mode. The second temperature is a target temperature in the fixing mode. That is, the second temperature is a temperature lower than the first temperature. Meanwhile, as illustrated in FIG. 1, the display section 110 includes a button 150 (operation section) for switching the fixing device 32 between the decoloring mode and the fixing mode.

Next, the decurling device 60 will be described.

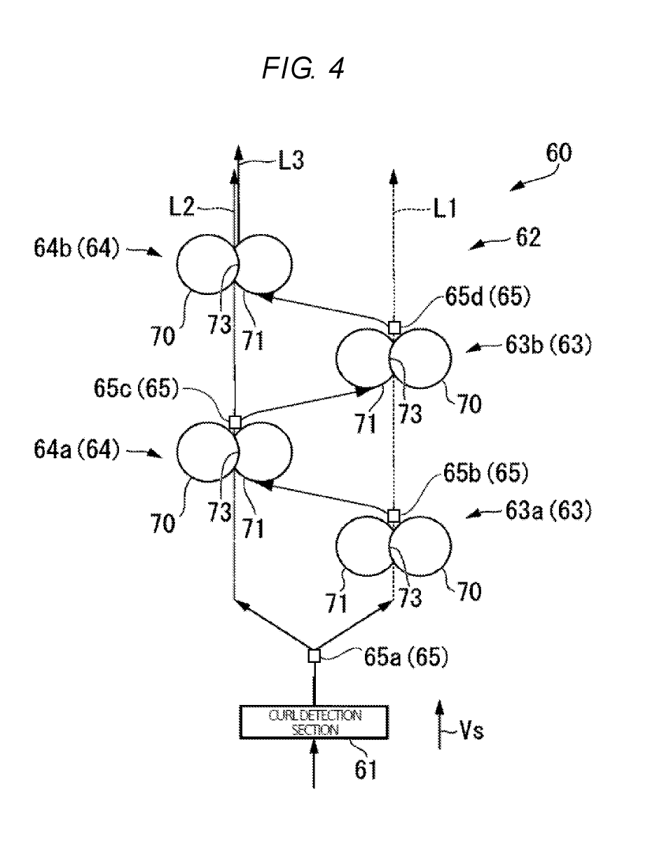

FIG. 4 is a diagram illustrating an example of a schematic configuration of the decurling device 60 according to the embodiment.

As illustrated in FIG. 4, the decurling device 60 includes a curl detection section 61 and a decurling mechanism 62.

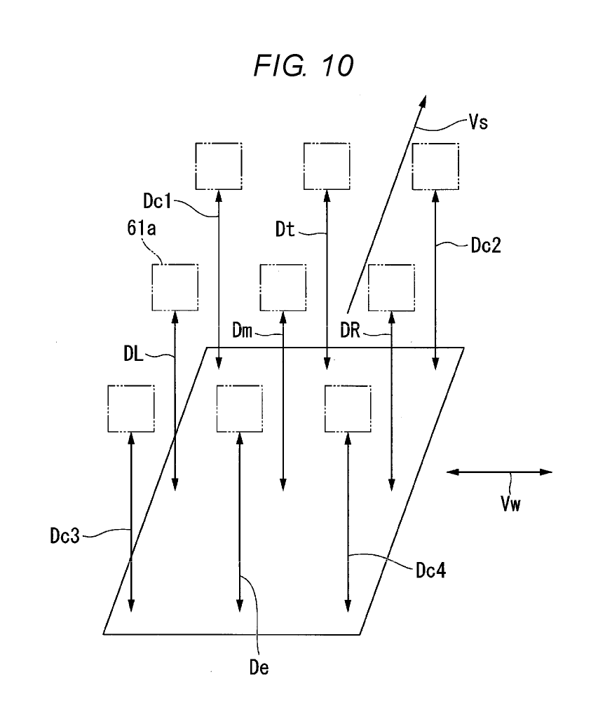

First, the curl detection section 61 will be described. The curl detection section 61 is disposed on a downstream side of the registration section 35 (see FIG. 2) in the sheet conveying direction Vs. The curl detection section 61 detects a curled state of a sheet, in particular the amount and direction of the curl. For example, the curl detection section 61 includes a laser displacement gauge 61a (see FIG. 10) that measures the amount of displacement of the sheet. For example, the plurality of laser displacement gauges 61a are provided at fixed positions so as to be capable of irradiating the entire sheet with a laser. Meanwhile, the laser displacement gauge 61a may be configured to be movable by a driving mechanism including a motor so as to be capable of irradiating the entire sheet with a laser. For example, the driving mechanism may include a frame supporting the laser displacement gauge 61a, a rack-and-pinion mechanism that moves the frame along a guide rail, and the like. A detection result of the curl detection section 61 is output to the control section 101 as a signal for detecting the curled state of the sheet. Meanwhile, the curl detection section 61 may include an ultrasonic sensor.

Next, the decurling mechanism 62 will be described.

The decurling mechanism 62 includes a plurality of curl correction mechanisms 63a, 63b, 64a, and 64b and a plurality of conveying path switching mechanisms 65a, 65b, 65c, and 65d.

In the embodiment, the decurling mechanism 62 includes four curl correction mechanisms 63a, 63b, 64a, and 64b and four conveying path switching mechanisms 65a, 65b, 65c, and 65d. Hereinafter, the “conveying path switching mechanisms 65a, 65b, 65c, and 65d” may be simply referred to as a “conveying path switching mechanism 65”.

First, the curl correction mechanisms 63a, 63b, 64a, and 64b will be described. In a case where the sheet is curled, the curl correction mechanisms 63a, 63b, 64a, and 64b correct a curl by applying a curve to a sheet in an opposite direction of the curl of the curled sheet. At least two of the plurality of curl correction mechanisms 63a, 63b, 64a, and 64b have different curvature directions of curves to be applied to the sheet.

In the embodiment, two curl correction mechanisms 63a and 63b among the four curl correction mechanisms 63a, 63b, 64a, and 64b have directions of curves to be applied to the sheet which are different from those of the remaining curl correction mechanisms 64a and 64b. Hereinafter, the curl correction mechanisms 63a and 63b applying the direction of a first curve to a sheet will be referred to as “first curl correction mechanisms 63a and 63b”, and the curl correction mechanisms 64a and 64b applying the direction of a second curve, which is opposite to the direction of the first curve, to the sheet will be referred to as “second curl correction mechanisms 64a and 64b”. Hereinafter, the “first curl correction mechanisms 63a and 63b” may be simply referred to as a “first curl correction mechanism. 63”, and the “second curl correction mechanisms 64a and 64b” may be simply referred to as a “second curl correction mechanism 64”.

In the embodiment, the four curl correction mechanisms 63a, 63b, 64a, and 64b include two first curl correction mechanisms 63a and 63b and two second curl correction mechanisms 64a and 64b.

The two first curl correction mechanisms 63a and 63b include the upstream-side first curl correction mechanism 63a and the downstream-side first curl correction mechanism 63b which are separated from each other in the sheet conveying direction Vs.

The two second curl correction mechanisms 64a and 64b include the upstream-side second curl correction mechanism 64a and the downstream-side second curl correction mechanism 64b which are separated from each other in the sheet conveying direction Vs.

The two first curl correction mechanisms 63a and 63b and the two second curl correction mechanisms 64a and 64b are separated from each other in a direction intersecting the sheet conveying direction Vs. The four curl correction mechanisms 63a, 63b, 64a, and 64b are alternately disposed toward the downstream side in the sheet conveying direction Vs in order of the upstream-side first curl correction mechanism 63a, the upstream-side second curl correction mechanism 64a, the downstream-side first curl correction mechanism 63b, and the downstream-side second curl correction mechanism 64b.

The first curl correction mechanism 63 and the second curl correction mechanism 64 have different directions of curves to be applied to a sheet, but have the same components. Consequently, the first curl correction mechanism 63 will be described as a representative of the curl correction mechanisms 63a, 63b, 64a, and 64b, and the second curl correction mechanism 64 will not be described here.

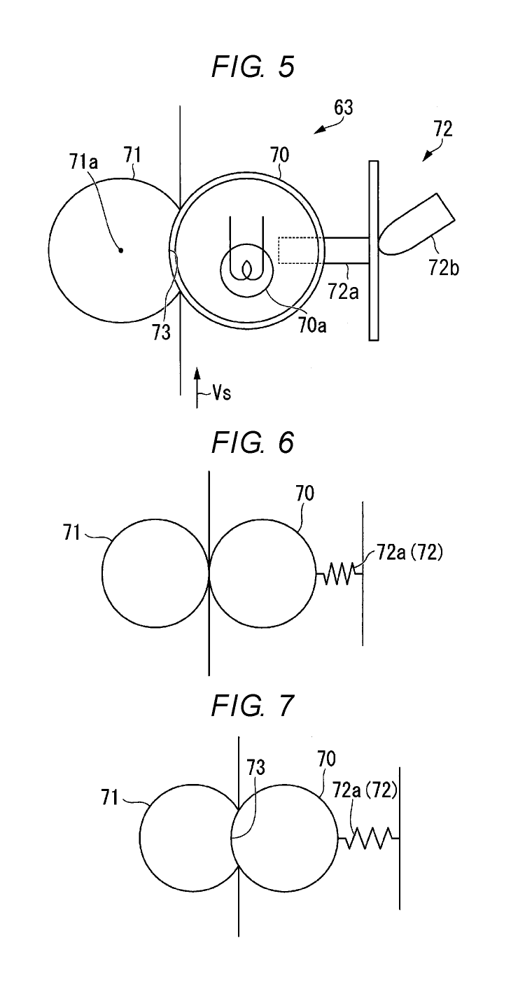

FIG. 5 is a diagram illustrating an example of a schematic configuration of the first curl correction mechanism 63 according to the embodiment.

As illustrated in FIG. 5, the first curl correction mechanism 63 includes a hard roller 70, a soft roller 71, and a correction force setting section 72. Meanwhile, the hard roller 70 is corresponding to a first roller described in claims, and the soft roller 71 is corresponding to a second roller described in claims.

First, the hard roller 70 will be described.

The hard roller 70 is disposed on a downstream side of the curl detection section 61 (see FIG. 4) in the sheet conveying direction Vs. The hard roller 70 has a curved outer circumferential surface. Specifically, the hard roller 70 has a cylindrical shape. The hard roller 70 includes a roller made of a metal or a resin. Meanwhile, the hard roller 70 may be configured to rotatably follow the rotation of the soft roller 71.

A heat source 70a (hereinafter, referred to as a “decurling heat source 70a”), which heats the hard roller 70, is provided inside the hard roller 70 (internal space). For example, the decurling heat source 70a may be a resistive heating element such as a thermal head, a ceramic heater, a halogen lamp, an electromagnetic induction heating unit, or the like. Meanwhile, the decurling heat source 70a is not limited to being disposed inside the hard roller 70, and may be disposed outside the hard roller 70.

Next, the soft roller 71 will be described.

The soft roller 71 has a curved outer circumferential surface. Specifically, the soft roller 71 has a columnar shape. The soft roller 71 has a diameter which is slightly smaller than that of the hard roller 70. The outer circumferential surface of the soft roller 71 has a hardness lower than that of the hard roller 70. The soft roller 71 includes a roller made of rubber or sponge. The soft roller 71 is rotatable about a central shaft 71a by a driving mechanism such as a motor.

Next, the correction force setting section 72 will be described.

The correction force setting section 72 sets the strength of a correction force of a curl based on the first curl correction mechanism 63. The correction force setting section 72 presses the hard roller 70 toward the soft roller 71 to thereby form a nip 73 between the hard roller 70 and the soft roller 71. The nip 73 has a shape in which the soft roller 71 is deformed along the outer circumference of the hard roller 70. A sheet conveyed to the first curl correction mechanism 63 is applied a curl along the shape of the nip 73. That is, the sheet conveyed to the first curl correction mechanism 63 is applied a curl having a shape along the outer circumference of the hard roller 70. The correction force setting section 72 sets a different correction force by adjusting a pressing force (hereinafter, referred to as “nip pressure”) which is generated in the nip 73 formed by the hard roller 70 and the soft roller 71.

In the embodiment, the correction force setting section 72 includes a biasing member 72a, a cam 72b, and a driving mechanism (not shown). For example, the biasing member 72a is a spring such as a plate spring or a coil spring. The cam 72b is moved about a supporting point (not shown) by a driving mechanism including a motor and the like. The cam 72b is moved against a biasing force of the biasing member 72a to be capable of adjusting a biting amount of the soft roller 71 with respect to the hard roller 70.

Next, the operation of the hard roller 70 will be described.

The correction force setting section 72 moves the hard roller 70 independently of the soft roller 71 to be capable of increasing or decreasing nip pressure. The correction force setting section 72 moves the hard roller 70 between a first position and a second position (FIG. 5). Here, the first position is a position at which the hard roller 70 and the soft roller 71 are in point-contact with each other. The second position is a position at which the hard roller 70 is elastically bitten into the soft roller 71 in a radial direction.

FIG. 6 is a schematic diagram when the hard roller 70 is positioned at the first position. FIG. 7 is a schematic diagram when the hard roller 70 is positioned at the second position. Meanwhile, in FIGS. 6 and 7, the cam 72b and the like are not illustrated for convenience of description, and the biasing member 72a is illustrated as a coil spring so that the biased state of the biasing member 72a can be seen.

As illustrated in FIG. 6, the external shape (circular shape) of the soft roller 71 is maintained at the first position. At the first position, the outer circumferential circle of the hard roller 70 and the outer circumferential circle of the soft roller 71 form a common tangent.

As illustrated in FIG. 7, the soft roller 71 becomes depressed in the form of an arc due to the pressing of the hard roller 70 at the second position. At the second position, the hard roller 70 forms the arc-shaped nip 73 together with the soft roller 71. At the second position, predetermined nip pressure is secured. Meanwhile, the soft roller 71 is configured to be rotatable at the second position in a state where the predetermined nip pressure is secured. That is, in a state where the hard roller 70 is bitten into the soft roller 71 in the radial direction, the soft roller 71 is rotatable about the central shaft 71a (see FIG. 5) by a driving mechanism such as a motor.

The correction force setting section 72 can increase or decrease nip pressure between first nip pressure and second nip pressure stronger than the first nip pressure. Here, the first nip pressure means nip pressure at the first position (see FIG. 6). The second nip pressure means nip pressure at the second position (see FIG. 7). For example, the first nip pressure may have nip pressure by which the sheet can be conveyed. The correction force setting section 72 applies a biasing force, which is stronger than a biasing force in a case of setting nip pressure to be the first nip pressure, to the hard roller 70 to thereby set nip pressure to be the second nip pressure. For example, in a case where the sheet is curled, the second nip pressure may have nip pressure by which the sheet can be decurled. Meanwhile, the correction force setting section 72 may be a stepping motor, a solenoid, or the like. The correction force setting section 72 may be capable of setting nip pressure by driving the hard roller 70.

Next, the conveying path switching mechanism 65 will be described.

The conveying path switching mechanism 65 can switch a conveying path of a sheet. As illustrated in FIG. 4, a plurality of conveying paths L1, L2, and L3 are formed on a downstream side of the curl detection section 61 in the sheet conveying direction Vs. In the embodiment, the three conveying paths L1, L2, and L3 are provided on a downstream side of the curl detection section 61 in the sheet conveying direction Vs. Hereinafter, the conveying path L1, which passes through only two first curl correction mechanisms 63a and 63b, will be referred to as a “first conveying path L1”. The conveying path L2, which passes through only two second curl correction mechanisms 64a and 64b, will be referred to as a “second conveying path L2”. The conveying path L3, which passes through all of the four curl correction mechanisms 63a, 63b, 64a, and 64b in order of the upstream-side first curl correction mechanism 63a, the upstream-side second curl correction mechanism 64a, the downstream-side first curl correction mechanism 63b, and the downstream-side second curl correction mechanism 64b, will be referred to as a “third conveying path L3”.

The plurality of conveying path switching mechanisms 65a, 65b, 65c, and 65d switch a conveying path of a sheet so that the sheet passes through at least two of the plurality of curl correction mechanisms 63a, 63b, 64a, and 64b.

Specifically, when switching to the first conveying path L1 is performed, the two conveying path switching mechanisms 65a and 65b switch the conveying path of the sheet so that the sheet passes through the upstream-side first curl correction mechanism 63a and the downstream-side first curl correction mechanism 63b in this order.

When switching to the second conveying path L2 is performed, the two conveying path switching mechanisms 65a and 65c switch the conveying path of the sheet so that the sheet passes through the upstream-side second curl correction mechanism 64a and the downstream-side second curl correction mechanism 64b in this order.

When switching to the third conveying path L3 is performed, the four conveying path switching mechanisms 65a, 65b, 65c, and 65d switch the conveying path of the sheet so that the sheet passes through the two curl correction mechanisms 63 and 64 having different directions of curves to be applied to the sheet. In the embodiment, when switching to the third conveying path L3 is performed, the four conveying path switching mechanisms 65a, 65b, 65c, and 65d switch the conveying path of the sheet so that the sheet passes through all of the four curl correction mechanisms 63a, 63b, 64a, and 64b in order of the upstream-side first curl correction mechanism 63a, the upstream-side second curl correction mechanism 64a, the downstream-side first curl correction mechanism 63b, and the downstream-side second curl correction mechanism 64b.

In the embodiment, the four conveying path switching mechanisms 65a, 65b, 65c, and 65d include the first conveying path switching mechanism 65a, the second conveying path switching mechanism 65b, the third conveying path switching mechanism 65c, and the fourth conveying path switching mechanism 65d.

The first conveying path switching mechanism 65a is disposed between the curl detection section 61 and the upstream-side first curl correction mechanism 63a in the sheet conveying direction Vs. The first conveying path switching mechanism 65a is positioned at the uppermost stream side among the four conveying path switching mechanisms 65a, 65b, 65c, and 65d. The first conveying path switching mechanism 65a switches between the upstream-side first curl correction mechanism 63a and the upstream-side second curl correction mechanism 64a through which the sheet, which passed through the curl detection section 61, passes.

The second conveying path switching mechanism 65b is disposed between the two first curl correction mechanisms 63a and 63b in the sheet conveying direction Vs. The second conveying path switching mechanism 65b is disposed close to the upstream-side first curl correction mechanism 63a on the first conveying path L1. The second conveying path switching mechanism 65b switches between the downstream-side first curl correction mechanism 63b and the upstream-side second curl correction mechanism 64a through which the sheet, which passed through the upstream-side first curl correction mechanism 63a, passes.

The third conveying path switching mechanism 65c is disposed between the two second curl correction mechanisms 64a and 64b in the sheet conveying direction Vs. The third conveying path switching mechanism 65c is disposed close to the upstream-side second curl correction mechanism 64a on the second conveying path L2. The third conveying path switching mechanism 65c switches between the downstream-side first curl correction mechanism 63b and the downstream-side second curl correction mechanism 64b through which the sheet passing through the upstream-side second curl correction mechanism 64a passes.

The fourth conveying path switching mechanism 65d is disposed on a downstream side of the downstream-side first curl correction mechanism 63b in the sheet conveying direction Vs. The fourth conveying path switching mechanism 65d is positioned on the most downstream side among the four conveying path switching mechanisms 65a, 65b, 65c, and 65d. The fourth conveying path switching mechanism 65d is disposed close to the downstream-side first curl correction mechanism. 63b on the first conveying path L1. The fourth conveying path switching mechanism 65d switches between the first conveying path L1 and the downstream-side second curl correction mechanism 64b through which the sheet, which passed through the downstream-side first curl correction mechanism 63b, passes.

The first conveying path switching mechanism 65a, the second conveying path switching mechanism 65b, the third conveying path switching mechanism 65c, and the fourth conveying path switching mechanism 65d differ from each other in a position at which the sheet is switched, but have the same components. Consequently, the first conveying path switching mechanism 65a will be described as a representative of the conveying path switching mechanism 65, and the second conveying path switching mechanism 65b, the third conveying path switching mechanism 65c, and the fourth conveying path switching mechanism 65d will not be described here.

For example, the first conveying path switching mechanism 65a includes a branching claw not shown in the drawing, and a driving mechanism. The driving mechanism includes a motor and the like. In accordance with the operation of the driving mechanism, the branching claw can switch between the upstream-side first curl correction mechanism 63a and the upstream-side second curl correction mechanism 64a through which the sheet passing through the curl detection section 61 passes.

Next, a functional configuration of the image forming apparatus 1 will be described.

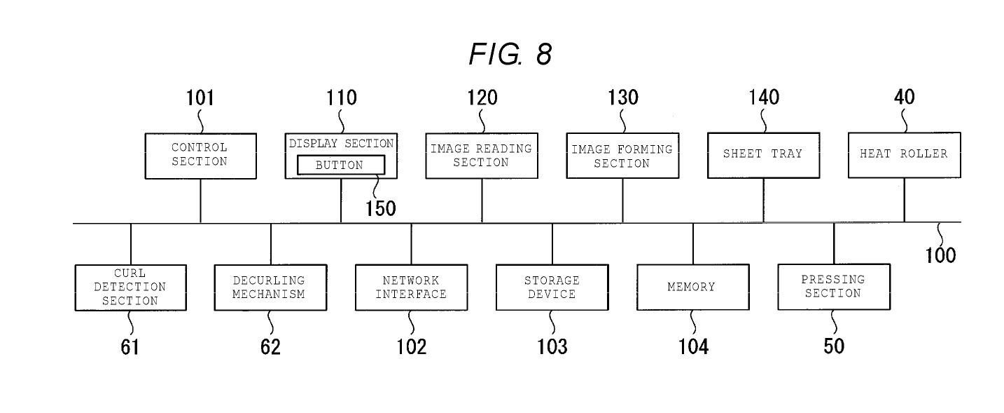

FIG. 8 is a block diagram illustrating an example of a functional configuration of the image forming apparatus 1 according to the embodiment.

As illustrated in FIG. 8, functional sections of the image forming apparatus 1 are connected to each other so as to be capable of performing data communication through a system bus 100.

The control section 101 controls the operation of each functional section of the image forming apparatus 1. The control section 101 performs various processes by executing a program. The control section 101 acquires an instruction which is input by a user from the display section 110. The control section 101 performs a control process on the basis of the acquired instruction.

The network interface 102 transmits and receives data to and from another device. The network interface 102 operates as an input interface and receives data transmitted from another device. In addition, the network interface 102 also operates as an output interface, and transmits data to another device.

The storage device 103 stores various pieces of data. For example, the storage device 103 is a hard disk drive (HDD) or a solid state drive (SSD). For example, various pieces of data are digital data, screen data of a setting screen, setting information, a job, a job log, and the like. The digital data is data generated by the image reading section 120. The setting screen is a screen for performing setting of the operation of the decurling mechanism 62 (specifically, the plurality of curl correction mechanisms 63a, 63b, 64a, and 64b and the plurality of conveying path switching mechanisms 65a, 65b, 65c, and 65d which are illustrated in FIG. 4). The setting information is information regarding the setting of the operation of the decurling mechanism 62 (specifically, the plurality of curl correction mechanisms 63a, 63b, 64a, and 64b and the plurality of conveying path switching mechanisms 65a, 65b, 65c, and 65d which are illustrated in FIG. 4).

The memory 104 temporarily stores data used by each functional section shown in FIG. 8. For example, the memory 104 is a random access memory (RAM). For example, the memory 104 temporarily stores digital data, a job, a job log, and the like.

Next, the operation of the decurling mechanism 62 according to a state of curling of a sheet will be described.

The control section 101 controls the operation of the decurling mechanism 62 in accordance with the state of curling of the sheet.

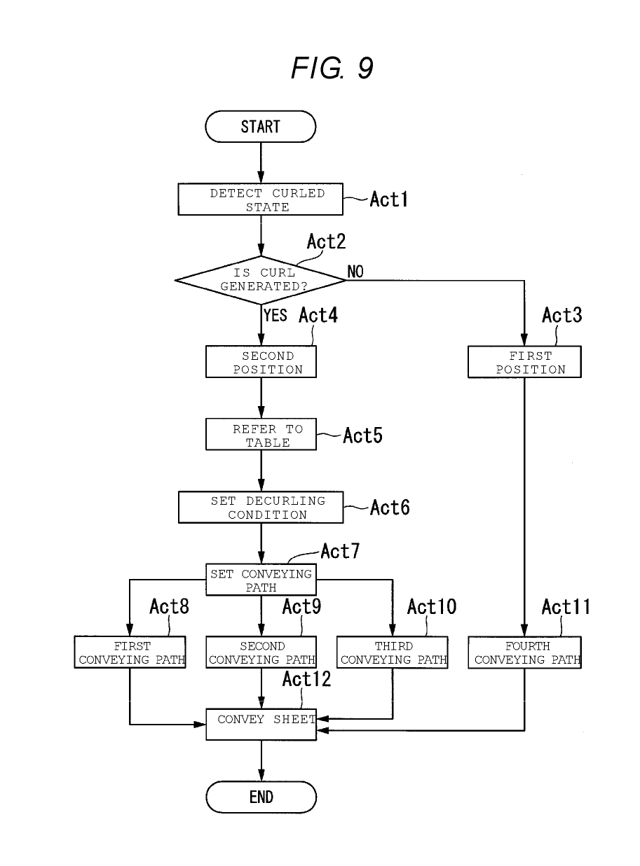

FIG. 9 depicts a flowchart of an example of the operation of the decurling mechanism 62 according to the embodiment.

As illustrated in FIG. 9, in Act1, the curl detection section 61 detects a state of curling of a sheet. For example, the curl detection section 61 measures a time until a laser reflected from the sheet returns to the laser displacement gauge 61a to thereby detect the amount and direction of a curl. Meanwhile, when the curled state of the sheet is detected, a conveying mechanism not shown in the drawing conveys the sheet to a predetermined position. Here, the predetermined position means a position at which the curled state of the sheet can be detected by the curl detection section 61. For example, the predetermined position is a position at which the sheet is not interposed between a pair of rollers and the like.

Next, an example of a method of detecting a curled state of a sheet will be described.

FIG. 10 is a diagram illustrating an example of a method of detecting a curled state of a sheet according to the embodiment. Meanwhile, in FIG. 10, the laser displacement gauge 61a is shown as a virtual line (dashed line) for convenience of description.

In FIG. 10, a distance between the sheet and the laser displacement gauge 61a in the vicinity of the center in the sheet conveying direction Vs is set to be a “center distance Dm”, a distance between the sheet and the laser displacement gauge 61a in the vicinity of a downstream end (tip end) in the sheet conveying direction Vs is set to be a “tip end distance Dt”, a distance between the sheet and the laser displacement gauge 61a in the vicinity of an upstream end (rear end) in the sheet conveying direction Vs is set to be a “rear end distance De”, a distance between the sheet and the laser displacement gauge 61a in the vicinity of a left end in a sheet width direction Vw perpendicular to the sheet conveying direction Vs is set to be a “left end distance DL”, a distance between the sheet and the laser displacement gauge 61a in the vicinity of a right end in the sheet width direction Vw is set to be a “right end distance DR”, a distance between the sheet and the laser displacement gauge 61a in the vicinity of the downstream end (tip end) in the sheet conveying direction Vs and the left end in the sheet width direction Vw is set to be a “first angle distance Dc1”, a distance between the sheet and the laser displacement gauge 61a in the vicinity of the downstream end (tip end) in the sheet conveying direction Vs and the right end in the sheet width direction Vw is set to be a “second angle distance Dc2”, a distance between the sheet and the laser displacement gauge 61a in the vicinity of the upstream end (rear end) in the sheet conveying direction Vs and the left end in the sheet width direction Vw is set to be a “third angle distance Dc3”, and a distance between the sheet and the laser displacement gauge 61a in the vicinity of the upstream end (rear end) in the sheet conveying direction Vs and the right end in the sheet width direction Vw is set to be a “fourth angle distance Dc4”.

The amount of curling can be represented by an absolute value of a difference between the center distance Dm and any of the tip end distance Dt, the rear end distance De, the left end distance DL, the right end distance DR, the first angle distance Dc1, the second angle distance Dc2, the third angle distance Dc3, and the fourth angle distance Dc4. The direction of a curl can be determined depending on the length of each of the center distance Dm, the tip end distance Dt, the rear end distance De, the left end distance DL, the right end distance DR, the first angle distance Dc1, the second angle distance Dc2, the third angle distance Dc3, and the fourth angle distance Dc4. For example, the control section 101 determines that a curl is generated when the amount of curling exceeds a threshold value of the amount of curling which is stored in the storage device 103 in advance.

As a result of the detection of the curled state, in a case where it is determined in Act2 that a curl is not generated (Act2; No), the process proceeds to Act3. In Act3, the hard roller 70 is maintained at the first position. For example, the control section 101 controls the correction force setting section 72 and stops the hard roller 70 at the first position. That is, the correction force setting section 72 sets nip pressure to be the first nip pressure. For example, the control section 101 sets a target temperature of the decurling heat source 70a to an initial value (standard temperature) which is stored in the storage device 103 in advance. For example, the control section 101 sets a rotation speed of the soft roller 71 to an initial value (standard rotation speed) which is stored in the storage device 103 in advance.

On the other hand, in a case where it is determined that a curl is generated (Act2; Yes), the process proceeds to Act4. In Act4, the hard roller 70 is moved to the second position. For example, the control section 101 controls the correction force setting section 72 and moves the hard roller 70 to the second position. That is, the correction force setting section 72 sets nip pressure to be the second nip pressure.

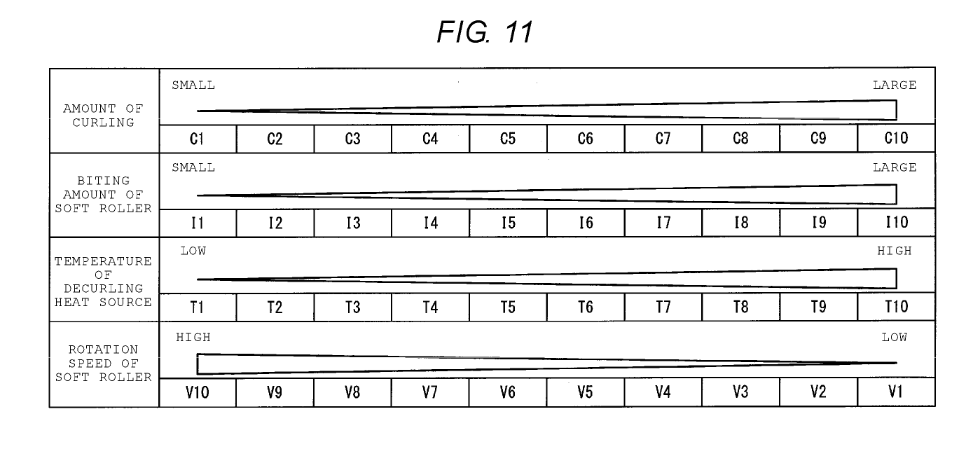

In Act5 to Act6, the control section 101 sets decurling conditions on the basis of a table (see FIG. 11).

In Act5, the table shown in FIG. 11 is referred to. For example, a table during the setting of decurling conditions is stored in the storage device 103 in advance on the basis of a detection result (specifically, the amount of curl) of the curl detection section 61.

FIG. 11 is a diagram illustrating an example of a table for the setting of decurling conditions on the basis of a detection result (specifically, the amount of curl) of the curl detection section 61 according to the embodiment. In the embodiment, the decurling conditions include the amount of biting of the soft roller 71 with respect to the hard roller 70, the target temperature of the decurling heat source 70a, and a rotation speed of the soft roller 71. Hereinafter, the amount of biting of the soft roller 71 with respect to the hard roller 70 will be referred to as a “soft roller biting amount”, the target temperature of the decurling heat source 70a will be referred to as a “decurling heat source temperature”, and the rotation speed of the soft roller 71 will be referred to as a “soft roller rotation speed”.

In FIG. 11, the amount of curling is set in a range between C1 and C10. C1 indicates a relatively small amount of curl, and C10 indicates a relatively large amount of curling. The amount of curling increases toward C10 in the range between C1 and C10.

The soft roller biting amount is set in a range between I1 and I10. I1 is a relatively small biting amount, and I10 is a relatively large biting amount. I1 indicates corresponding to the amount of biting when the hard roller 70 is positioned close to the first position between the first position and the second position. I10 indicates corresponding to the amount of biting when the hard roller 70 is positioned at the second position (that is, when the hard roller is farthest from the first position). The soft roller biting amount increases toward I10 in the range between I1 and I10.

The decurling heat source temperature is set in a range between T1 and T10. T1 indicates a relative low temperature, and T10 indicates a relative high temperature. The decurling heat source temperature becomes higher toward T10 in the range between T1 and T10.

The soft roller rotation speed is set in a range between V1 and V10. V1 indicates a relatively low rotation speed, and V10 indicates a relatively high rotation speed. The soft roller rotation speed becomes higher toward V10.

In Act6, the control section 101 sets decurling conditions on the basis of a table.

For example, in a case where a sheet is curled, a decurling effect is increased as a curvature of the curve to be applied to the sheet in a direction opposite to the curl becomes larger, and thus the following control is performed. The control section 101 increases the soft roller biting amount as the amount of curling increases.

For example, there is a tendency for the stress of the sheet to be alleviated and a decurling effect becomes larger as the sheet heating temperature becomes higher, and thus the following control is performed. The control section 101 increases the decurling heat source temperature as the amount of curling increases.

For example, a period of time for which decurling is applied to the sheet increases as the conveying speed of the sheet becomes lower, and thus the following control is performed. The control section 101 reduces the soft roller rotation speed as the amount of curling increases.

In the embodiment, the decurling conditions are set on the basis of the table, and thus it is possible to perform appropriate decurling.

Meanwhile, the control section 101 may control any of the soft roller biting amount, the decurling heat source temperature, the soft roller rotation speed, or may control all of the soft roller biting amount, the decurling heat source temperature, and the soft roller rotation speed. In addition, the control section 101 may maintain initial values of both the decurling heat source temperature and the soft roller rotation speed. That is, the control section 101 can arbitrarily set decurling conditions on the basis of the amount of curling.

In Act7 to Act10, the control section 101 sets a conveying path of the sheet.

In Act7, the conveying path of the sheet is set by controlling the four conveying path switching mechanisms 65a, 65b, 65c, and 65d. For example, a table (not shown) during the setting of the conveying path of the sheet is stored in the storage device 103 in advance on the basis of a detection result (specifically, the direction of a curl) of the curl detection section 61.

For example, in a case where the sheet is curled, a decurling effect becomes larger as the number of times the sheet is curved in a direction opposite to the curl, increases, and thus the following control is performed. Here, a curl generated in the sheet and generated in a direction which is opposite to the curve in the first curl correction mechanism 63 (that is, the same direction as the curve in the second curl correction mechanism 64) is referred to as a “first curl”, and a curl generated in a direction which is opposite to the curve in the second curl correction mechanism 64 (that is, the same direction as the curve in the first curl correction mechanism 63) is referred to as a “second curl”.

In a case where the sheet has the first curl, the control section 101 causes the process to proceed to Act8. In Act8, the control section 101 controls the first conveying path switching mechanism 65a and the second conveying path switching mechanism 65b, and switches the conveying path so that the sheet, which passed through the curl detection section 61, passes through the first conveying path L1.

After the switching to the first conveying path L1 is performed, the process proceeds to Act12. In Act12, the sheet is conveyed. The sheet having the first curl passes through the first conveying path L1. In the first conveying path L1, the sheet having the first curl is applied a curve twice in a direction opposite to the first curl by the two first curl correction mechanisms 63a and 63b, and thus it is possible to perform appropriate decurling to decrease the amount of curling of the sheet.

In a case where the sheet has a second curl, the control section 101 causes the process to proceed to Act9. In Act9, the control section 101 controls the first conveying path switching mechanism 65a and the third conveying path switching mechanism 65c, and switches the conveying path so that the sheet, which passed through the curl detection section 61, passes through the second conveying path L2.

After the switching to the second conveying path L2 is performed, the process proceeds to Act12. In Act12, the sheet is conveyed. The sheet having the second curl passes through the second conveying path L2. In the second conveying path L2, the sheet having the second curl is curled twice in a direction opposite to the second curl by the two second curl correction mechanisms 64a and 64b, and thus it is possible to perform appropriate decurling.

In a case where the sheet has the first curl or the second curl, the control section 101 may cause the process to proceed to Act10. In Act10, the control section 101 controls the four conveying path switching mechanisms 65a, 65b, 65c, and 65d, and switches the conveying path so that the sheet, which passed through the curl detection section 61, passes through the third conveying path L3.

After the switching to the third conveying path L3 is performed, the process proceeds to Act12. In Act12, the sheet is conveyed. The sheet having the first curl or the second curl passes through the third conveying path L3.

In the third conveying path L3, the sheet having the first curl is applied a first curve in the same direction as the first curl by the upstream-side first curl correction mechanism. 63a, and is then applied a second curve in a direction opposite to the first curve by the upstream-side second curl correction mechanism 64a. The sheet passing through the upstream-side second curl correction mechanism 64a is applied a first curve in a direction opposite to a second curve by the downstream-side first curl correction mechanism 63b, and is then applied the second curve in a direction opposite to the first curve by the downstream-side second curl correction mechanism 64b.

On the other hand, in the third conveying path L3, the sheet having the second curl is applied a first curve in a direction opposite to a second curl by the upstream-side first curl correction mechanism 63a, and is then applied the second curve in a direction opposite to the first curve by the downstream-side second curl correction mechanism 64a. The sheet passing through the upstream-side second curl correction mechanism 64a is applied a first curve in a direction opposite to a second curve by the downstream-side first curl correction mechanism 63b, and is then applied the second curve in a direction opposite to the first curve by the downstream-side second curl correction mechanism 64b.

In the third conveying path L3, in a case where the sheet has either the first curl or the second curl, the sheet is applied a first curve by the upstream-side first curl correction mechanism 63a. The sheet is applied the first curve and is then applied curves in opposite directions in order of the second curve, the first curve, and the second curve, and thus it is possible to perform appropriate decurling.

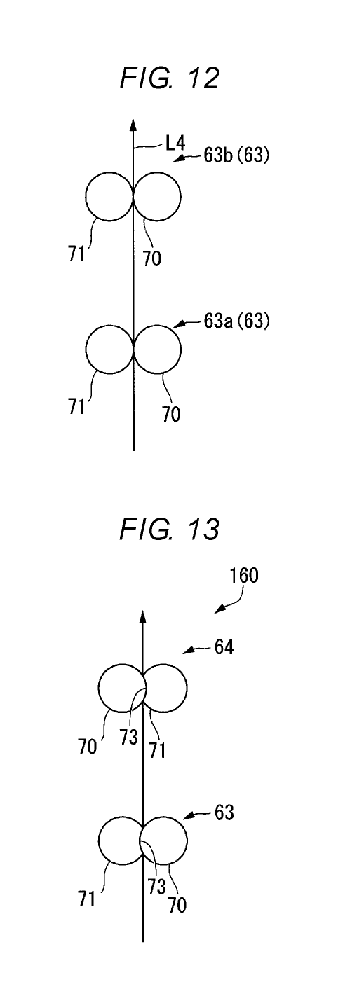

In a case where it is determined that a curl is not generated (Act2; No), the control section 101 causes the process to proceed to Act11 after going through Act3. In Act11, the control section 101 controls the first conveying path switching mechanism 65a, and switches the conveying path so that the sheet, which passed through the curl detection section 61, passes through the fourth conveying path L4 (see FIG. 12).

FIG. 12 is a diagram illustrating an example of the fourth conveying path L4 according to the embodiment.

As illustrated in FIG. 12, the fourth conveying path L4 has a linear shape. Meanwhile, the fourth conveying path L4 is corresponding to a conveying path when the hard roller 70 is positioned at the first position in the first conveying path L1 or the second conveying path L2. In FIG. 12, a conveying path when the hard roller 70 in the two first curl correction mechanisms 63a and 63b forming the first conveying path L1 is positioned at the first position is illustrated as the fourth conveying path L4.

After the switching to the fourth conveying path L4 is performed, the process proceeds to Act12. In Act12, the sheet is conveyed. The sheet that does not have a curl passes through the fourth conveying path L4 having a linear shape. An effect of curling the sheet becomes larger as the conveying path of the sheet becomes closer to a straight line, which is suitable for suppressing the generation of a curl in the sheet that does not have a curl.

Incidentally, a curl may be generated in the sheet due to pressing during the conveyance thereof, or the like. The generation of the curl may result in paper jamming due to inappropriate conveyance of the sheet in the middle of a sheet conveying path and defective loading in a paper discharge tray. A conventional image forming apparatus including a curl removing device for decurling is known. The curl removing device in the conventional image forming apparatus is provided at one predetermined position in the middle of the conveying path. However, in a configuration in which the curl removing device is provided only at one predetermined position, there is a possibility that it is not possible to perform appropriate decurling in a case where an excessively large curl is generated to such an extent that correction is not completely performed by one decurling operation.

According to the embodiment, the image forming section 130, the paper feed section 20, and the plurality of curl correction mechanisms 63a, 63b, 64a, and 64b are provided. The image forming section 130 forms an image on a sheet. The paper feed section 20 feeds the sheet toward the image forming section 130. The plurality of curl correction mechanisms 63a, 63b, 64a, and 64b are disposed on a downstream side of the paper feed section 20 in the sheet conveying direction Vs. In a case where the sheet is curled, the plurality of curl correction mechanisms 63a, 63b, 64a, and 64b correct a curl by curving the sheet in the decurling direction. At least two of the plurality of curl correction mechanisms 63a, 63b, 64a, and 64b have different directions of curves applied to the sheet.

According to the above-described configuration of the embodiment, the following effects are exhibited. It is possible to curve the curled sheet in the decurling direction a plurality of times by the plurality of curl correction mechanisms 63a, 63b, 64a, and 64b. Therefore, it is possible to perform appropriate decurling even when an excessively large curl is generated to such an extent that correction is not completely performed by one decurling operation. In addition, at least two of the plurality of curl correction mechanisms 63a, 63b, 64a, and 64b have different directions of curves applied to the sheet, and thus it is possible to curve the sheet in the decurling direction to decrease the amount of curling of the sheet based on the direction of curl of the sheet. Therefore, it is possible to perform appropriate decurling even when the directions of curls of the sheet are different at each sheet.

The curl correction mechanism includes the correction force setting section 72 that sets different correction forces by adjusting nip pressure, and thus the following effects are exhibited. The nip pressure is changed depending on the amount of curling of the sheet, and thus it is possible to apply an appropriate correction force of decurling to the sheet to decrease the amount of curling of the sheet based on the amount of curl of the sheet. Therefore, it is possible to perform appropriate decurling even when the amounts of curl of the sheets are different at each sheet.

The plurality of conveying path switching mechanisms 65a, 65b, 65c, and 65d switching the conveying path of the sheet so that the sheet passes through at least two of the plurality of curl correction mechanisms 63a, 63b, 64a, and 64b are further provided, and thus the following effects are exhibited. The sheet passes through at least two of the plurality of curl correction mechanisms 63a, 63b, 64a, and 64b by the plurality of conveying path switching mechanisms 65a, 65b, 65c, and 65d performing an operation of switching the conveying path of the sheet, and thus it is possible to attempt decurling of the curled sheet at least twice. Therefore, it is possible to easily perform appropriate decurling by the operation of switching the conveying path of the sheet even when an excessively large curl is generated to such an extent that correction of the curl is not completely performed by one decurling operation.

Hereinafter, a modification example will be described.

The decurling mechanism 62 is not limited to the configuration including four curl correction mechanisms 63a, 63b, 64a, and 64b and four conveying path switching mechanisms 65a, 65b, 65c, and 65d. For example, the decurling device 60 may include only two curl correction mechanisms 63 and 64.

FIG. 13 is a diagram illustrating a schematic configuration of a decurling device according to the modification example of the embodiment.

As illustrated in FIG. 13, a decurling device 160 according to this modification example includes only two curl correction mechanisms 63 and 64. The decurling device 160 includes one first curl correction mechanism 63 and one second curl correction mechanism 64. The decurling device 160 does not include the conveying path switching mechanism 65 (see FIG. 4).

According to this modification example, in a case where a sheet has either a first curl or a second curl, the sheet is applied the first curve by the first curl correction mechanism. 63 and is then applied the second curve in the second curl correction mechanism 64. The sheet is applied curves in opposite directions twice in order of the first curve and the second curve, and thus it is possible to perform appropriate decurling. In addition, it is possible to achieve simplification of the configuration of the decurling device 60 and a reduction in the weight thereof, as compared to a case where four curl correction mechanisms 63a, 63b, 64a, and 64b are provided.

The decurling heat source 70a is not limited to being disposed only inside the hard roller 70. For example, the decurling heat source 70a may be disposed only inside the soft roller 71. That is, the decurling heat source 70a may be disposed at least one of inside the hard roller 70 and inside the soft roller 71. Meanwhile, in a case where the decurling heat source 70a is provided inside the soft roller 71, the soft roller 71 is set to be a roller capable of withstanding heat generated from the decurling heat source 70a.

The image forming apparatus may further include a winding prevention mechanism 80 capable of suppressing the winding of the sheet with respect to a member holding a toner image.

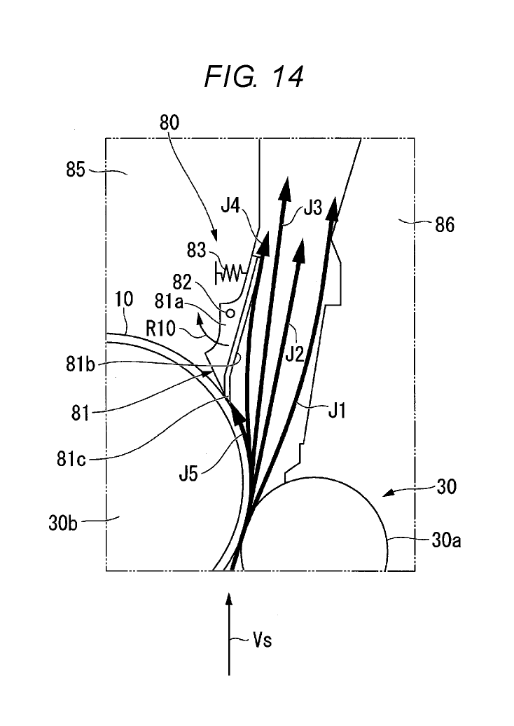

FIG. 14 is a diagram illustrating a schematic configuration of the winding prevention mechanism 80 according to the modification example of the embodiment.

As illustrated in FIG. 14, the winding prevention mechanism 80 is disposed on a downstream side of the image forming section 130 (specifically, the secondary transfer section 30) in the sheet conveying direction Vs. In this modification example, the member holding the toner image is the intermediate transfer body 10 stretching over the secondary transfer counter roller 30b.

The winding prevention mechanism 80 faces the secondary transfer counter roller 30b across the intermediate transfer body 10. The winding prevention mechanism 80 includes a guide claw 81, a shaft 82, and a biasing member 83. Meanwhile, in FIG. 14, reference numerals 85 and 86 respectively denote conveying path forming members forming a conveying path on a downstream side of the secondary transfer section 30.

The guide claw 81 includes a guide claw main body 81a, a guide portion 81b, and a claw portion 81c.

The guide claw main body 81a extends along the sheet conveying direction Vs. The guide claw main body 81a is rotatably supported by the shaft 82.

The guide portion 81b is provided on the conveying path side with respect to the guide claw main body 81a. The guide portion 81b extends along the sheet conveying direction Vs. In order to smoothly guide the sheet, a surface of the guide portion 81b on the sheet conveying path side (hereinafter, referred to as a “guide surface”) is configured as a smooth surface.

The claw portion 81c has a sharp-pointed shape having an acute angle toward the secondary transfer counter roller 30b. The claw portion 81c is directed toward a nip between the secondary transfer roller 30a and the secondary transfer counter roller 30b. As a result, the claw portion 81c and the secondary transfer counter roller 30b sandwich the intermediate transfer body 10.

The shaft 82 is positioned on a downstream side of the secondary transfer counter roller 30b in the sheet conveying direction Vs. The shaft 82 has a long side in the sheet width direction Vw. That is, the shaft 82 is parallel to the central shaft line of the secondary transfer counter roller 30b. Both ends of the shaft 82 are fixed to the conveying path forming member 85.

The biasing member 83 biases the guide claw 81 toward the secondary transfer counter roller 30b. A clockwise (right-handed, in a direction of an arrow R10) biasing force about the shaft 82 is applied to the guide claw 81 at all times. For example, the biasing member 83 is a coil spring. An end of the biasing member 83 is connected to the conveying path forming member 85. The other end of the biasing member 83 is connected to a portion of the guide claw main body 81a on a side opposite to the claw portion 81c with respect to the shaft 82 and opposite to the guide portion 81b with respect to the shaft 82.

Incidentally, a curl may be generated in the sheet due to heat or pressing during the transfer thereof, a transferred toner, or the like. In particular, in a case where the sheet is curled after the transfer, there is an increasing possibility that the sheet is wound around the member holding the toner image.

According to this modification example, the winding prevention mechanism 80 capable of suppressing the winding of the sheet around the intermediate transfer body 10 stretching over the secondary transfer counter roller 30b is further provided, and thus it is possible to suppress the winding of the sheet around the intermediate transfer body 10 even when the sheet is curled after the secondary transfer.

Incidentally, even when it is possible to suppress the winding of the sheet around the intermediate transfer body 10 stretching over the secondary transfer counter roller 30b, a surface of the sheet on which toner image is transferred comes into contact with the guide surface of the guide claw 81 and thus there is an increasing possibility that the toner image transferred on the sheet is disturbed, or a toner and dirt such as paper dust is attached to the surface on which toner image is transferred.

In FIG. 14, five routes of a sheet, which passed through the secondary transfer section 30, are illustrated. Regarding the five routes J1, J2, J3, J4, and J5, a frequency at which the sheet is wound around the intermediate transfer body 10 stretching over the secondary transfer counter roller 30b increases toward the route J5.

According to this modification example, the decurling device 60 is disposed between the registration section 35 and the first guide 36 in the sheet conveying direction Vs, and thus it is possible to reduce a frequency at which the sheet passes through the routes J4 and J5. Thereby, it is possible to prevent the surface of the sheet on which toner image is transferred from coming into contact with the guide surface of the guide claw 81. Therefore, it is possible to avoid the disturbance of an image transferred on the sheet surface or the attachment of a toner and dirt such as paper dust to the sheet surface.

The decurling device 60 is not limited to being disposed between the registration section 35 and the first guide 36 in the sheet conveying direction Vs. For example, the decurling device 60 may be disposed on a downstream side of the fixing device 32 in the sheet conveying direction Vs. The plurality of curl correction mechanisms 63a, 63b, 64a, and 64b may correct the curl by curving the sheet in the decurling direction in a case where the image formed on the sheet is decolored once or more.

Incidentally, a curl may be generated in the sheet due to heat or pressing during the fixing or decoloring thereof, a fixed toner, or the like. In addition, in a case where the sheet is repeatedly decolored, a curl may be generated due to a difference in contraction between the front surface and the rear surface of the sheet which is caused by a difference in the amount of evaporation of moisture contained in the sheet.

According to this modification example, the decurling device 60 is disposed on a downstream side of the fixing device 32 in the sheet conveying direction Vs, and thus it is possible to perform appropriate decurling, which leads to preferable results, even when a curl is generated in the sheet due to a fixing process or a decoloring process.

Incidentally, a method of using a sheet by performing printing and the like after decoloring is given as a method of reusing the sheet. However, according to the inventor's examination, a lift may occur at a predetermined position of the sheet due to a decoloring process performed on the sheet. In particular, in a case where a decoloring process is repeatedly performed on one sheet, it becomes apparent that a lift (hereinafter, referred to as an “uplift amount”) occurring at the predetermined position of the sheet becomes larger as the number of repeated time of decoloring processes on the same sheet (hereinafter, referred to as “the number of times of decoloring”) increases.

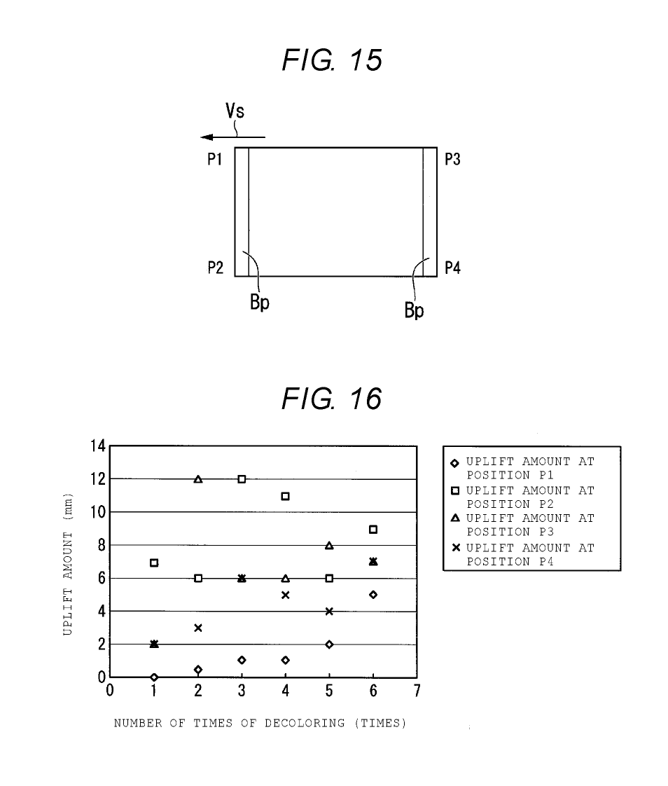

FIG. 15 is a diagram illustrating a sheet used for the examination of an uplift amount.

As illustrated in FIG. 15, a predetermined position of the sheet is a position in, for example, a corner portion of the sheet. In FIG. 15, positions P1 and P2 are illustrated at a downstream end of the sheet (tip end of the sheet) in the sheet conveying direction Vs, and positions P3 and P4 are illustrated at an upstream end of the sheet (rear end of the sheet) in the sheet conveying direction Vs. A belt-like pattern Bp is printed on a tip end portion and a rear end portion of the sheet in the sheet conveying direction Vs.

FIG. 16 is a diagram illustrating a relationship between the number of times of decoloring and an uplift amount. In FIG. 16, the horizontal axis is the number of times of decoloring (times), and the vertical shaft is an uplift amount (mm).

As illustrated in FIG. 16, although an uplift amount is partially shown, the uplift amount of 5 mm or more is confirmed on a surface side of the sheet on which the image is formed from first decoloring. When the printing of the belt-like pattern Bp and the decoloring process are repeatedly performed after the first decoloring is performed, an uplift amount of 10 mm or more is confirmed. In particular, it is confirmed that an uplift amount increases as the number of times of decoloring increases at the position P1 of the sheet.

According to this modification example, the decurling device 60 is disposed on a downstream side of the fixing device 32 in the sheet conveying direction Vs, and thus it is possible to perform appropriate decurling, which leads to preferable results, even when an uplift amount increases as the number of times of decoloring increases.

Incidentally, a curl may be generated in the sheet due to heat or pressing during the fixing or decoloring thereof, a fixed toner, or the like. In particular, in a case where a sheet made of a resin (hereinafter, referred to as a “resin sheet”) is used, there is a tendency for a curve to be generated due to heat, thereby increasing a possibility that a curl is generated. According to the inventor's examination, the direction of the curl in the resin sheet may be specified due to a decoloring process performed on the resin sheet. In particular, in a case where a decoloring process is performed on an A4-sized resin sheet, it becomes apparent that an uplift amount increases toward both ends in the long-side direction of the resin sheet, regardless of the sheet conveying direction Vs. This is because the direction of contraction of the resin sheet due to heat is limited.

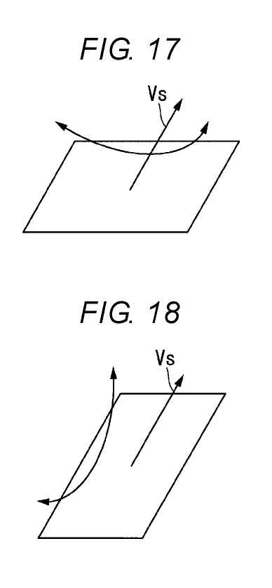

FIG. 17 is a diagram illustrating a resin sheet based on A4 setting which is used for the examination of an uplift amount.

As illustrated in FIG. 17, the resin sheet is disposed such that the long side thereof is perpendicular to the sheet conveying direction Vs. In FIG. 17, the feed of the resin sheet is performed based on A4 setting. Although not shown in the drawing, solid printing is uniformly performed on a surface of the resin sheet. When the resin sheet is confirmed after decoloring is performed (after first decoloring is performed), an uplift on a sheet surface on which an image is formed is confirmed in both ends in the long-side direction of the resin sheet. That is, a curl having an uplift amount increasing toward both ends in the long-side direction of the resin sheet is confirmed.

FIG. 18 is a diagram illustrating a resin sheet based on A4R setting which is used for the examination of an uplift amount.

As illustrated in FIG. 18, the resin sheet is disposed such that the short side thereof is perpendicular to the sheet conveying direction Vs. In FIG. 18, the feed of the resin sheet is performed based on A4R setting. Although not shown in the drawing, solid printing is uniformly performed on a surface of the resin sheet. When the resin sheet is confirmed after decoloring is performed (after first decoloring is performed), an uplift on a surface on which an image is formed is confirmed in both ends in the long-side direction of the resin sheet. That is, a curl having an uplift amount increasing toward both ends in the long-side direction of the resin sheet is confirmed.

According to this modification example, the decurling device 60 is disposed on a downstream side of the fixing device 32 in the sheet conveying direction Vs, and thus it is possible to perform appropriate decurling, which leads to preferable results, even when an uplift amount increases toward both ends in the long-side direction of a resin sheet by a decoloring process in a case where the resin sheet is used.

The decurling device 60 is not limited to being applied to an image forming apparatus. For example, the decurling device 60 may be applied to a decoloring device.

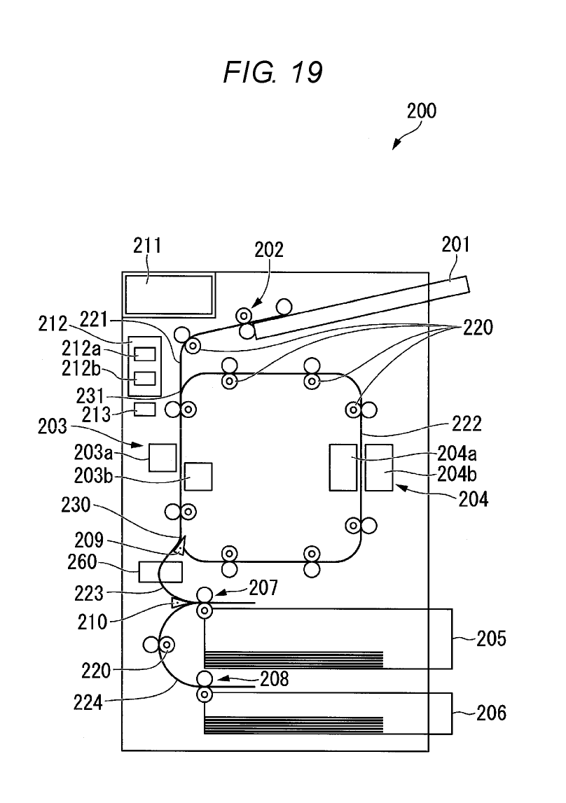

FIG. 19 is a diagram illustrating a schematic configuration of a decoloring device 200 according to a modification example of the embodiment.

As illustrated in FIG. 19, the decoloring device 200 includes a paper feed tray 201, a paper feed mechanism 202, a reading section 203, a decoloring section 204, a reuse tray 205, a reject tray 206, a first discharging mechanism 207, a second discharging mechanism 208, a first branching member 209, a second branching member 210, an operation section 211, a control section 212, a storage section 213, and a decurling device 260. The decoloring device 200 performs a decoloring process of removing the color of an image on a sheet on which the image is formed of a decolorable color material (hereinafter, referred to as a “recording material”) such as a decolorable toner or decolorable ink.

The decoloring device 200 further includes a plurality of conveying rollers 220 for forming a first conveying route 221, a second conveying route 222, a third conveying route 223, and a fourth conveying route 224.

The first conveying route 221 is a conveying path toward the branch point 230 from the paper feed tray 201.

The second conveying route 222 is a conveying path which branches from the first conveying route 221 at a branch point 230, is curved toward a junction 231 positioned on an upstream side of the reading section 203, and joins the first conveying route 221 at the junction 231. That is, the first conveying route 221 and the second conveying route 222 form a conveying path circulating through the branch point 230 and the junction 231.

The third conveying route 223 is a conveying path which connects with the first conveying route 221 at the branch point 230 and is directed toward an inlet of the reuse tray 205 from the branch point 230.

The fourth conveying route 224 is a conveying path which connects with the third conveying route 223 through the second branching member 210 and is directed toward an inlet of the reject tray 206 from the second branching member 210.

On the paper feed tray 201, sheets to be reused (subjected to be decolored by the decoloring device 200) are loaded. For example, the sheets to be reused are sheets on which an image is formed of the recording material.

The paper feed mechanism 202 is disposed in a portion of the paper feed tray 201 which is close to the first conveying route 221. The paper feed mechanism 202 includes a pickup roller, a sheet supply roller, and a separation roller. The paper feed mechanism 202 feeds the sheets on the paper feed tray 201 one by one to the first conveying route 221 inside the decoloring device 200.

The reading section 203 is disposed on a downstream side of the paper feed tray 201 along the first conveying route 221. The reading section 203 includes a first reading unit 203a and a second reading unit 203b facing each other across the first conveying route 221. The first reading unit 203a reads an image on a first surface (front surface) of the sheet to be conveyed. The second reading unit 203b reads an image on a second surface (rear surface) which is opposite to the first surface of the sheet to be conveyed. That is, the reading section 203 reads images on both surfaces of the sheet to be conveyed through the first conveying route 221 by the first reading unit 203a and the second reading unit 203b.

The decoloring section 204 includes a first decoloring unit 204a and a second decoloring unit 204b facing each other across the second conveying route 222. The decoloring section 204 performs a decoloring process of removing the color of images on both surfaces of a sheet to be conveyed. For example, the decoloring section 204 heats the sheet to be conveyed up to a decoloring temperature in a state of coming into contact with the sheet to thereby decolor an image which is formed of the recording material on the sheet. The first decoloring unit 204a heats the sheet by abutting on the sheet from one surface side of the sheet. The second decoloring unit 204b heats the sheet by abutting on the sheet from the other surface side of the sheet. That is, the decoloring section 204 decolors the images on both surfaces of the sheet to be conveyed by one conveyance.

The reuse tray 205 and the reject tray 206 are disposed at a lower portion of the decoloring device 200. The reuse tray 205 and the reject tray 206 are disposed so as to be arranged in the vertical direction. For example, the reuse tray 205 accommodates a sheet which is set to be reusable by the decoloring of an image on the sheet. For example, the reject tray 206 accommodates a sheet determined not to be reusable.

The first discharging mechanism 207 and the second discharging mechanism 208 are disposed at an inlet of the reuse tray 205 and an inlet of the reject tray 206, respectively. The first discharging mechanism 207 and the second discharging mechanism 208 discharge a sheet to the reuse tray 205 and the reject tray 206, respectively.

The first branching member 209 is disposed on a downstream side of the reading section 203. The first branching member 209 is disposed at the branch point 230 of the first conveying route 221. The first branching member 209 switches a conveying direction of the sheet which is conveyed to the branch point 230 through the reading section 203. Specifically, the first branching member 209 selectively allocates the sheet, which is conveyed through the first conveying route 221, to the second conveying route 222 or the third conveying route 223.

For example, in a normal state (non-driven state), the first branching member 209 permits the sheet to be conveyed from the first conveying route 221 to the third conveying path 200.

On the other hand, in a driven state, the first branching member 209 inhibits the sheet from being conveyed from the first conveying route 221 to the third conveying path 200. That is, in the driven state, the sheet is conveyed from the first conveying route 221 to the second conveying route 222.

Since the first conveying route 221 and the second conveying route 222 form a conveying path circulating through the branch point 230 and the junction 231, the decoloring device 200 can convey the sheet, which is conveyed from the reading section 203, to the reading section 203 again through the decoloring section 204. Specifically, the decoloring device 200 guides the sheet, which is supplied from the paper feed mechanism. 202, to the reading section 203 through the junction 231 by the first conveying route 221, guides the sheet processed by the reading section 203 to the second conveying route 222 at the branch point 230 by controlling the first branching member 209, and conveys the sheet to the decoloring section 204 and the reading section 203 through the junction 231 in this order.

The second branching member 210 is disposed close to the first discharging mechanism 207. The second branching member 210 is disposed at a connection point between the third conveying route 223 and the fourth conveying route 224. The second branching member 210 switches a conveying direction of the sheet passing through the branch point 230. The second branching member 210 selectively allocates the sheet, which is conveyed through the third conveying route 223, to the reuse tray 205 or the fourth conveying route 224.

For example, in the normal state (non-driven state), the second branching member 210 inhibits the sheet from being conveyed from the third conveying route 223 to the fourth conveying route 224. That is, in the normal state (non-driven state), the sheet is accommodated in the reuse tray 205.

On the other hand, in the driven state, the second branching member 210 inhibits the sheet from being conveyed from the third conveying route 223 to the reuse tray 205. That is, in the driven state, the sheet is conveyed to the fourth conveying route 224 and is accommodated in the reject tray 206.

The operation section 211 is disposed at an upper portion of the main body of the decoloring device 200. For example, the operation section 211 includes a touch panel type display section and various operation keys. A user instructs a functional operation of the decoloring device 200, such as the start of a decoloring process or the reading of an image on a sheet to be decolored, through the operation section 211. A display section of the operation section 211 displays, for example, setting information, operation status, log information, and the like of the decoloring device 200. Meanwhile, the operation section 211 may be connected to an operation device of an external device through a network, and may be operable from an external operation device.

The control section 212 includes a processor 212a and a memory 212b.

The processor 212a includes a central processing unit (CPU) or a micro processing unit (MPU).

For example, the memory 212b is a semiconductor memory. The memory 212b includes a read only memory (ROM) and a random access memory (RAM).

The ROM stores various control programs. For example, the ROM stores a coverage rate of printing on a sheet which is set to be a threshold value regarding whether or not a sheet can be reused, an image density threshold value for determining whether or not an image is decoloring, and the like.

The RAM provides a temporary work area to the processor 212a. For example, the RAM temporarily stores an image read by the reading section 203.

The control section 212 controls each section of the decoloring device 200 on the basis of various programs and the like stored in the ROM or the storage section 213.

The storage section 213 stores an image read by the reading section 203. For example, the storage section 213 includes a semiconductor storage device such as a hard disk drive, other magnetic storage devices, an optical storage device, or a flash memory, or any combination thereof. For example, the control section 212 stores an image on a sheet which is read by the reading section 203 in the storage section 213 before the decoloring section 204 performs a decoloring process. Hereinafter, a process of storing an image on a sheet, which is read by the reading section 203, in the storage section 213 will be referred to as a “image storing process”. The decoloring section 204 performs an image storing process before performing a decoloring process, and thus it is possible to acquire image data in a case where data of an image decolored is required later.

The decurling device 260 is provided on the third conveying route 223 branching from the branch point 230. In a case where a sheet is curled due to a curve portion of the above-described circulating conveying path, the decurling device 260 performs decurling process on the sheet. The decurling device 260 and the decurling device 60 (see FIG. 4) according to the embodiment have different directions of the entrance of a sheet, but have the same components. Therefore, the decurling device 260 will not be described here.

Hereinafter, examples of processes performed by the decoloring device 200 according to this modification example will be described.

The decoloring device 200 performs the following six operation modes.
First decoloring mode: an image storing process is not performed, and only a decoloring process is performed.
Second decoloring mode: a decoloring process is performed after an image storing process is performed.
Third decoloring mode: an image storing process is not performed, and a classification process is performed after a decoloring process is performed.
Fourth decoloring mode: a decoloring process is performed after an image storing process is performed, and a classification process is further performed.
Fifth decoloring mode: a decoloring process is performed as necessary after a classification process is performed, and a classification process is further performed.
Reading mode: a decoloring process is not performed, and an image storing process is performed.

Which one of the above-described operation modes is to be performed can be selected by the operation section 211 of the decoloring device 200. Meanwhile, the classification process means a process of causing the control section 212 to determine whether or not a sheet can be reused on the basis of an image, indicating the state of a surface of a sheet, which is read by the reading section 203, and selectively allocating the sheet to the reuse tray 205 or the reject tray 206 in accordance with a determination result.

The first conveying route 221 to the fourth conveying route 224 are appropriately changed on the basis of the operation modes performed by the decoloring device 200. In the first to fifth decoloring modes, a sheet is necessarily conveyed to the decoloring section 204. On the other hand, in the reading mode, the decoloring device 200 discharges a sheet, which is conveyed through the first conveying route 221, from the reading section 203 through the branch point 230 and the third conveying route 223 without conveying the sheet to the decoloring section 204 through the second conveying route 222. In the reading mode, the first conveying route 221 and the third conveying route 223 are in a passable state.

The control section 212 controls the reading section 203, the decoloring section 204, and other components in accordance with the operation mode which is selected by a user. For example, in a case where the first to fifth decoloring modes selected, the control section 212 causes the decoloring section 204 to decolor an image on a sheet.

In a case where an image on a sheet is decolored by the decoloring section 204 and is then read by the reading section 203 (the third decoloring mode, the fourth decoloring mode, and the fifth decoloring mode), the control section 212 determines whether or not the sheet can be reused in accordance with the presence or absence of shadow due to a bended portion, a torn portion, or a wrinkled portion of the sheet and the ratio of an incompletely erased portion, on the basis of data of the image read by the reading section 203. The control section 212 determines a conveyance destination of the sheet to be the reuse tray 205 or the reject tray 206 on the basis of a result of the above-described determination (classification process). Meanwhile, the classification process may also serve as an image storing process. That is, the control section 212 may determine whether or not the sheet can be reused on the basis of the read image, and may store the read image in the storage section 213.

On the other hand, in a case where the reading section 203 reads the image of the sheet before the sheet is conveyed to the decoloring section 204 (the second decoloring mode, the fourth decoloring mode), the control section 212 stores the image read by the reading section 203 in the storage section 213 (storage process). Meanwhile, the control section 212 may determine whether or not prohibited data, such as secret data, which is to prohibit decoloring, is included in data of the image of the sheet which is read by the reading section 203.

In a case where the reading mode in which a decoloring process is not performed and the image of the sheet is read is set, the reading section 203 reads the image of the sheet and stores the read image in the storage section 213 (storage process). The control section 212 does not drive the first branching member 209 (does not convey the sheet on which reading is terminated to the decoloring section 204) and drives the second branching member 210 to discharge the sheet to the reject tray 206. Meanwhile, in the reading mode, the control section 212 may perform a classification process instead of an image storing process, or may perform both an image storing process and a classification process. That is, the control section 212 may classify the sheet into the reuse tray 205 or the reject tray 206 by causing the reading section 203 to read the image of the sheet in the reading mode and to store the read image in the storage section 213 and by determining whether or not the sheet can be reused, on the basis of the read image.

Incidentally, a curl may be generated in the sheet due to pressing during the conveyance thereof, heat or pressing during the decoloring thereof, or the like. The generation of the curl may result in paper jamming due to inappropriate conveyance of the sheet in the middle of a conveying path and defective loading in a paper discharge tray. A conventional image forming apparatus including a curl removing device for decurling is known. The curl removing device in the conventional image forming apparatus is provided at one predetermined position in the middle of the conveying path. However, in a configuration in which the curl removing device is provided only at one predetermined position, there is a possibility that it is not possible to perform appropriate decurling in a case where an excessively large curl is generated to such an extent that correction is not completely performed by one decurling operation. In addition, it is necessary to set a sheet in a predetermined direction in order to cope with a curl in a fixed direction.

According to this modification example, it is possible to curve a curled sheet in the decurling direction a plurality of times by the plurality of curl correction mechanisms 63a, 63b, 64a, and 64b. Therefore, it is possible to perform appropriate decurling even when an excessively large curl is generated to such an extent that correction is not completely performed by one decurling operation. In addition, at least two of the plurality of curl correction mechanisms 63a, 63b, 64a, and 64b have different directions of curves applied to the sheet, and thus it is possible to curve the sheet in the decurling direction to decrease the amount of curling of the sheet based on the direction of curl of the sheet. Therefore, it is possible to perform appropriate decurling even when the directions of curls of the sheet are different at each sheet. According to this modification example, it is not necessary to set a sheet in a predetermined direction in order to cope with a curl in a fixed direction and to perform appropriate decurling, which leads to preferable results.

According to the above-described image forming apparatus according to at least one embodiment, it is possible to perform appropriate decurling.

The function of the image forming apparatus according to the above-described embodiment may be realized by a computer. In this case, the function may be realized by recording a program for realizing this function in a computer-readable recording medium and causing a computer system to read and execute the program stored in the recording medium. Meanwhile, the “computer system” as used herein includes hardware such as an OS or peripheral devices. In addition, the “computer-readable recording medium.” refers to a portable medium such as a flexible disk, a magneto-optical disk, a ROM, and a CD-ROM or a storage device such as a hard disk built into a computer system. Further, the “computer-readable recording medium.” may include a medium that dynamically holds a program for a short period of time, such as a communication wire through which the program is transmitted via a network such as the Internet or a communication line such as a telephone line, and also include a medium that holds a program for a certain period of time, such as a volatile memory inside the computer system serving as a server or a client in that case. Further, the program may realize a portion of the above-mentioned function, or may realize the above-mentioned function in combination with programs already recorded in the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming section;
a sheet supply section; and
first and second curl correction mechanisms disposed in a sheet conveyance path between the sheet supply section and the image forming section, each curl correction mechanism configured to curve a recording medium conveyed thereto,
wherein the first and second curl correction mechanisms are configured to apply curves to the recording medium in different curvature directions.

2. The image forming apparatus according to claim 1, wherein each of the first and second curl correction mechanisms includes:
a first roller, and
a second roller that has a surface hardness lower than that of the first roller.

3. The image forming apparatus according to claim 2, wherein a position of the second roller is adjustable relative to the first roller, and position of the second roller relative to the first roller determines an amount of curve that is applied to the recording medium.

4. The image forming apparatus according to claim 3, wherein the second roller is moved into the position against a biasing force by rotating a cam.

5. The image forming apparatus according to claim 1, further comprising:
a curl detector disposed in the sheet conveyance path between the sheet supply section and the first and second curl correction mechanisms, the curl detector configured to detect a direction of the curl of the recording medium, wherein
if the direction of the curl is a first curvature direction, the first curl correction mechanism is selected to apply the curve to the recording medium in a second curvature direction that is opposite to the first curvature direction, and
if the direction of the curl is the second curvature direction, the second curl correction mechanism is selected to apply the curve to the recording medium in the first curvature direction.

6. The image forming apparatus according to claim 5, further comprising:
a conveying path switching mechanism configured to guide the recording medium to a first path along which the first curl correction mechanism is disposed if the direction of the curl is the first curvature direction and to a second path along which the second curl correction mechanism is disposed if the direction of the curl is the second curvature direction.

7. The image forming apparatus according to claim 1, further comprising:
third and fourth curl correction mechanisms disposed in the sheet conveyance path between the sheet supply section and the image forming section, wherein
the third curl correction mechanism is configured to curve the recording medium conveyed thereto in a same curvature direction as the first curl correction mechanism, and
the fourth curl correction mechanism is configured to curve the recording medium conveyed thereto in a same curvature direction as the second curl correction mechanism.

8. The image forming apparatus according to claim 5, further comprising:
a conveying path switching mechanism configured to guide the recording medium to either a first path along which the first and third curl correction mechanisms are disposed or a second path along which the second and fourth curl correction mechanisms are disposed.

9. The image forming apparatus according to claim 8, further comprising:
additional conveying path switching mechanisms including a first additional conveying path switching mechanism between the first and third curl correction mechanisms, a second additional conveying path switching mechanism between the second and fourth curl correction mechanisms, and a third additional conveying path switching mechanism between the third curl correction mechanism and the image forming section.

10. The image forming apparatus according to claim 9, wherein
the first additional conveying path switching mechanism is configured guide the recording medium toward the second curl correction mechanism or the third curl correction mechanism,
the second additional conveying path switching mechanism is configured guide the recording medium toward the third curl correction mechanism or the fourth curl correction mechanism, and
the third additional conveying path switching mechanism is configured guide the recording medium toward the fourth curl correction mechanism or the image forming section.

11. A method of decurling a recording medium in an image forming apparatus, comprising:
detecting a direction of a curl in a recording medium;
if the direction of the curl is a first curvature direction, guiding the recording medium to a first curl correction mechanism to apply a curve in a second curvature direction that is opposite to the first curvature direction; and
if the direction of the curl is the curvature direction, guiding the recording medium to a second curl correction mechanism to apply a curve in the first curvature direction.

12. The method of claim 11, wherein the image forming apparatus includes a sheet supply section from which the recording medium is conveyed, and image forming section, the first and second curl correction mechanisms being disposed in in a sheet conveyance path between the sheet supply section and the image forming section.

13. The method of claim 11, wherein each of the first and second curl correction mechanisms includes:
a first roller, and
a second roller that has a surface hardness lower than that of the first roller.

14. The method of claim 13, further comprising:
in either the first or second curl correction mechanism, adjusting a position of the second roller relative to the first roller to vary an amount of curve that is applied to the recording medium.

15. The method of claim 14, wherein the adjusting includes:
rotating a cam to move the second roller into the position against a biasing force.

16. The method of claim 11, further comprising:
after the first curl correction mechanism applies the curve in the second curvature direction to the recording medium, guiding the recording medium to a third curl correction mechanism that applies a curve in the second curvature direction to the recording medium.

17. The method of claim 16, further comprising:
after the third curl correction mechanism applies the curve in the second curvature direction to the recording medium, guiding the recording medium to a fourth curl correction mechanism that applies a curve in the first curvature direction to the recording medium.

18. The method of claim 11, further comprising:
after the first curl correction mechanism applies the curve in the second curvature direction to the recording medium, guiding the recording medium to the second curl correction mechanism to apply the curve in the first curvature direction to the recording medium.

19. The method of claim 11, further comprising:
after the second curl correction mechanism applies the curve in the first curvature direction to the recording medium, guiding the recording medium to a third curl correction mechanism that applies a curve in the second curvature direction to the recording medium.

20. The method of claim 11, further comprising:
after the second curl correction mechanism applies the curve in the first curvature direction to the recording medium, guiding the recording medium to a fourth curl correction mechanism that applies a curve in the first curvature direction to the recording medium.
